(19) United States
(12) Patent Application Publication
(10) Pub. No.: US 2026/0245929 A1
(43) Pub. Date: Aug. 20, 2026

(54) FUEL CELL SYSTEM

(71) Applicant: AISIN CORPORATION, Kariya, Aichi (JP)

(72) Inventors: Akihiro TAJIKARA, Kariya-shi, Aichi-ken (JP); Taiga MURAKAMI, Kariya-shi, Aichi-ken (JP)

(73) Assignee: AISIN CORPORATION, Kariya, Aichi (JP)

(21) Appl. No.: 19/160,526

(22) PCT Filed: Mar. 11, 2024
(86) PCT No.: PCT/JP2024/009386

§ 371 Date: Aug. 28, 2025

(30) Foreign Application Priority Data
Mar. 13, 2023 (JP) 2023-038993
Mar. 13, 2023 (JP) 2023-039005
Mar. 16, 2023 (JP) 2023-042307

(51) Int. Cl. H01M 8/04225; H01M 8/04223; H01M 8/04228; H01M 8/04302; H01M 8/04303; H01M 8/04664; H01M 8/04701; H01M 8/04746; H01M 8/04955; H01M 8/249

(52) U.S. Cl. CPC H01M 8/04225; H01M 8/04228; H01M 8/04268; H01M 8/04302; H01M 8/04303; H01M 8/04679; H01M 8/04701; H01M 8/04753; H01M 8/04955; H01M 8/249

(57) ABSTRACT

In a fuel cell system, fuel cell stacks are connected in series between a plurality of power generation units, and the fuel cell system includes a start-up control unit. When start-up of the system is requested, the start-up control unit supplies fuel gas and oxidant gas to each of the plurality of fuel cell stacks and burns the fuel gas and the oxidant gas in a combustion unit to start a warm-up operation of the plurality of fuel cell stacks, and when all of the plurality of fuel cell stacks are in a power generatable state, the start-up control unit starts current sweep to start power generation of the plurality of fuel cell stacks.

### CROSS REFERENCE TO RELATED APPLICATIONS

This application is a National Stage of International Application No. PCT/JP 2024/009386, filed Mar. 11, 2024, claiming priorities to Japanese Patent Application No. 2023-038993, filed Mar. 13, 2023, Japanese Patent Application No. 2023-039005, filed Mar. 13, 2023 and Japanese Patent Application No. 2023-042307, filed Mar. 16, 2023, the entire contents of which are incorporated in their entirety.

### TECHNICAL FIELD

The present specification discloses a fuel cell system.

### BACKGROUND ART

Conventionally, as this type of fuel cell system, there has been proposed a fuel cell system that includes a fuel cell stack and a temperature sensor that detects the temperature of a portion of the fuel cell stack having the highest temperature or the temperature in the vicinity thereof, and executes control to start power generation of the cell stack when the temperature detected by the temperature sensor reaches a predetermined temperature in a start-up process (see, for example, Patent Literature 1).

In addition, a fuel cell system in which a plurality of fuel cell stacks are connected in series has also been proposed (see, for example, Patent Literature 2).

### CITATION LIST

### Patent Literature

Patent Literature 1: JP 2009-32555 A
Patent Literature 2: JP 2012-533146 A

### SUMMARY OF THE DISCLOSURE

### Technical Problems

In a fuel cell system including a single fuel cell stack as in the fuel cell system described in Patent Literature 1 described above, degradation of the cell stack can be suppressed by starting power generation when the temperature of the stack reaches a predetermined temperature at which power can be generated in the start-up process.

However, as described in Patent Literature 2, in the fuel cell system including a plurality of fuel cell stacks, the temperature distribution is biased for each fuel cell stack.

Therefore, even if the temperatures of some fuel cell stacks reach the temperatures at which power can be generated, the temperatures of other fuel cell stacks may not reach the temperatures at which power can be generated. If current sweep is started in this state, an excessive current may flow through a fuel cell stack having a low temperature, and the fuel cell stack may be degraded.

The present disclosure provides a fuel cell system including a plurality of fuel cell stacks connected in series, in which degradation of the fuel cell stacks can be suppressed.

### Solutions To Problems

A fuel cell system of the present disclosure adopts the following means in order to achieve the above main object.

The fuel cell system of the present disclosure is a fuel cell system including a plurality of power generation units each of which includes one or more fuel cell stacks that generate power by a reaction between fuel gas and oxidant gas, a combustion unit that burns mixed gas of residual fuel gas and residual oxidant gas from the fuel cell stack, a heat insulating case that houses the fuel cell stack and the combustion unit, a fuel supply system that supplies the fuel gas to the fuel cell stack, and an oxidant gas supply system that supplies the oxidant gas to the fuel cell stack, in which fuel cell stacks are connected in series between the plurality of power generation units, the fuel cell system including a start-up control unit that, when start-up of the system is requested, supplies the fuel gas and the oxidant gas to each of the plurality of fuel cell stacks and burns the fuel gas and the oxidant gas in the combustion unit to start a warm-up operation of the plurality of fuel cell stacks, and when all of the plurality of fuel cell stacks are in a power generatable state, that starts current sweep to start power generation of the plurality of fuel cell stacks.

In the fuel cell system of the present disclosure, when all of the plurality of fuel cell stacks connected in series reach the power generatable state, the current sweep is started to cause the plurality of fuel cell stacks to simultaneously generate power. As a result, it is possible to prevent the current from being swept from some low-temperature fuel cell stacks and to suppress the degradation of the fuel cell stacks.

### BRIEF DESCRIPTION OF DRAWINGS

FIG. 1 is a schematic configuration diagram of a fuel cell system according to the present embodiment.

FIG. 2 is a schematic configuration diagram of a plurality of power generation units each including a power generation module and an auxiliary machine.

FIG. 3 is a schematic configuration diagram of the power generation module.

FIG. 4 is a flowchart illustrating an example of an integrated control device-side start-up process.

FIG. 5 is a flowchart illustrating an example of a module control device-side start-up process.

FIG. 6 is a flowchart illustrating an example of a warm-up start waiting time setting process.

FIG. 7 is an explanatory diagram illustrating a state of a temporal change in each power generation unit sequence in a comparative example.

FIG. 8 is an explanatory diagram illustrating a state of a temporal change in each power generation unit sequence in the present embodiment.

FIGS. 9A, 9B, and 9C are explanatory diagrams illustrating a cumulative fuel consumption amount during the warm-up operation of each power generation unit in the comparative example.

FIGS. 10A, 10B, and 10C are explanatory diagrams illustrating a cumulative fuel consumption amount during the warm-up operation of each power generation unit in the present embodiment.

FIGS. 11A, 11B, and 11C are explanatory diagrams illustrating the cumulative fuel consumption amount in a case where the combustion supply amount of a power generation unit that has completed warm-up before other units is reduced.

FIG. 12 is a flowchart illustrating an example of a warm-up fuel supply amount regulating process.

FIGS. 13A, 13B, and 13C are explanatory diagrams illustrating the cumulative fuel consumption amount when the warm-up operation is performed based on a target gradient in each power generation unit.

FIGS. 14A, 14B, and 14C are explanatory diagrams illustrating a state of a change in stack temperature when the warm-up operation is performed based on the target gradient in each power generation unit.

FIG. 15 is a flowchart illustrating an example of the warm-up fuel supply amount regulating process.

FIG. 16 is a flowchart illustrating an example of the integrated control device-side start-up process.

FIG. 17 is a flowchart illustrating an example of the module control device-side start-up process.

FIG. 18 is an explanatory diagram illustrating a state of a temporal change in stack temperature and open circuit voltage OCV (normal and abnormal) in a start-up process.

FIG. 19 is a flowchart illustrating an example of an integrated control device-side stop process.

FIG. 20 is a flowchart illustrating an example of a module control device-side stop process.

FIG. 21 is a schematic configuration diagram of a fuel cell system according to another embodiment.

FIG. 22 is a schematic configuration diagram of a power generation module according to another embodiment.

### DESCRIPTION OF EMBODIMENTS

Embodiments for carrying out the present disclosure will be described with reference to the drawings.

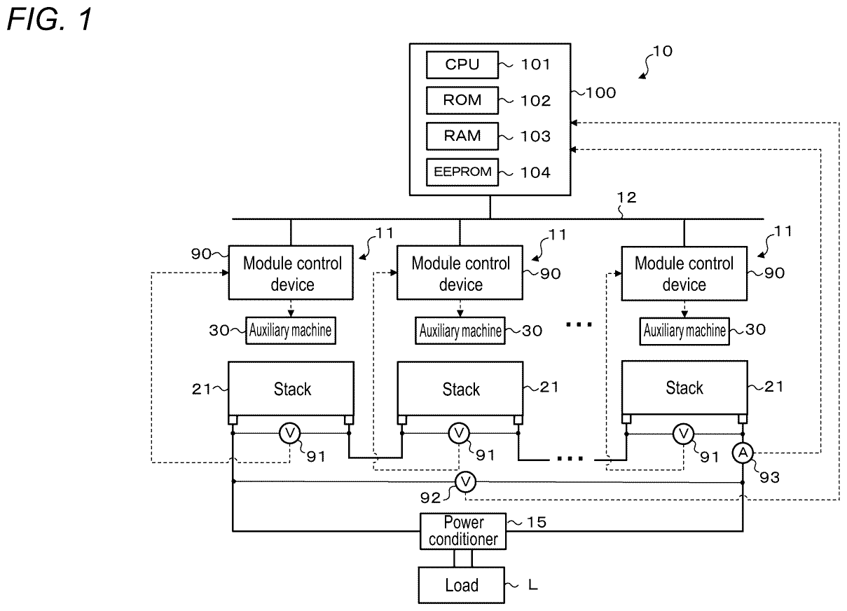

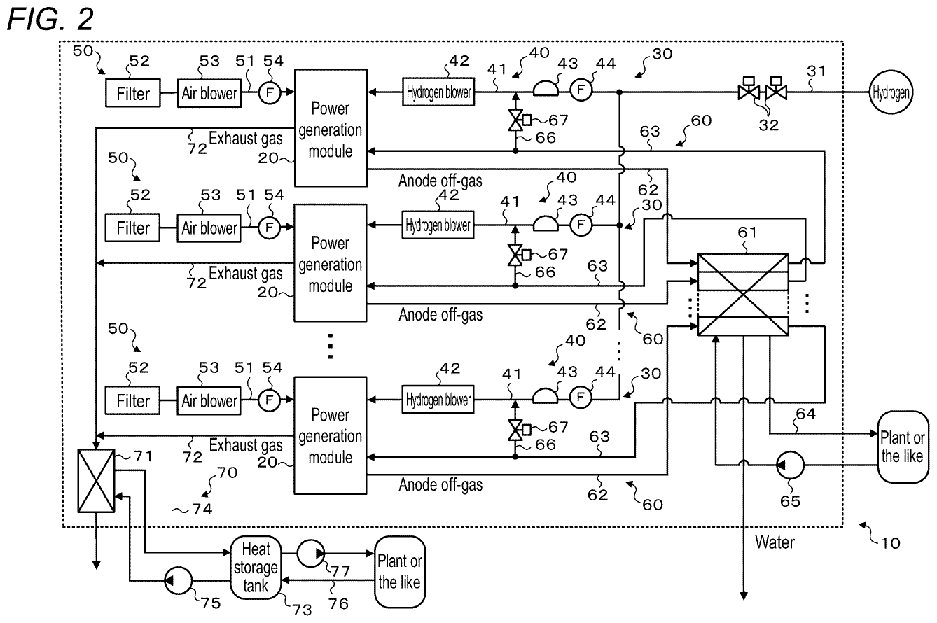

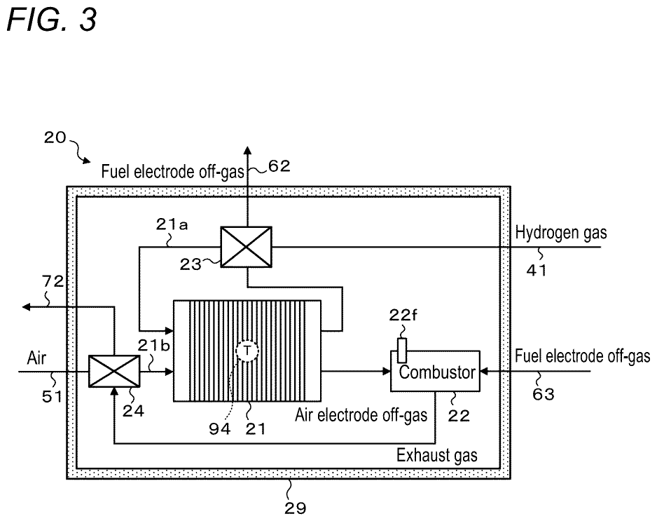

FIG. 1 is a schematic configuration diagram of a fuel cell system 10 according to the present embodiment, FIG. 2 is a schematic configuration diagram of a plurality of power generation units 11 each including a power generation module 20 and an auxiliary machine 30, and FIG. 3 is a schematic configuration diagram of the power generation module 20.

As illustrated in FIG. 1, the fuel cell system 10 of the embodiment includes a plurality of (n) power generation units 11 (first, second, . . . , nth power generation units) and an integrated control device 100 that manages the plurality of power generation units 11.

As illustrated in FIGS. 1 and 2, each of the plurality of power generation units 11 includes the power generation module 20 including a fuel cell stack 21, various auxiliary machines 30 necessary for operation of the fuel cell stack 21, and a module control device 90 that controls various auxiliary machines 30.

As illustrated in FIG. 3, the power generation module 20 includes a combustor 22, and heat exchangers 23 and 24 in addition to the fuel cell stack 21, and these components are housed in a module case 29 with a heat insulating property. The various auxiliary machines 30 include a fuel supply system 40, an air supply system 50, a circulation system 60, an exhaust heat recovery system 70, and the like (see FIG. 2).

The fuel cell stack 21 includes a plurality of solid oxide unit cells each including an electrolyte such as stabilized zirconia (for example, YSZ), a fuel electrode of a composite of a catalytic metal such as Ni and stabilized zirconia or the like disposed on one surface side of the electrolyte, and an air electrode such as LSCF disposed on the other surface side of the electrolyte. Each fuel cell stack 21 generates power by a reaction between hydrogen contained in fuel gas and oxygen contained in oxidant gas. A temperature sensor 94 is disposed near the fuel cell stack 21. The temperature sensor 94 detects a temperature (stack temperature Tst) correlated with the temperature of the fuel cell stack 21.

As illustrated in FIG. 3, a fuel gas supply pipe 21a is connected to a fuel electrode inlet of the fuel cell stack 21, and a heat exchanger 23 for exchanging heat between fuel gas flowing through the fuel gas supply pipe 21a and fuel electrode off-gas discharged from the fuel cell stack 21 is disposed in the fuel gas supply pipe 21a. In addition, an oxidant gas supply pipe 21b is connected to an air electrode inlet of the fuel cell stack 21, and the heat exchanger 24 for exchanging heat between air flowing through the oxidant gas supply pipe 21b and combustion exhaust gas discharged from the combustor 22 is disposed in the oxidant gas supply pipe 21b.

Hydrogen gas supplied as fuel gas by the fuel supply system 40 is introduced into the fuel electrode of the fuel cell stack 21 through the fuel gas supply pipe 21a, and air supplied as oxidant gas by the air supply system 50 is introduced into the air electrode of the fuel cell stack 21 through the oxidant gas supply pipe 21b. Oxide ions (O²⁻) are generated at the air electrode, and the oxide ions pass through the electrolyte and react with hydrogen at the fuel electrode, thereby obtaining electric energy. The fuel electrode off-gas that has not been used for the electrochemical reaction (power generation) in the fuel electrode of each unit cell exchanges heat with the fuel gas (hydrogen gas) supplied from the fuel supply system 40 to the fuel electrode in the heat exchanger 23, and then is discharged to the outside of the module case 29. The fuel electrode off-gas is then supplied to the circulation system 60 through a fuel electrode off-gas pipe 62, cooled by a condenser 61 provided in the circulation system 60 to remove water vapor contained in the fuel electrode off-gas, and then supplied to the combustor 22 through a fuel electrode off-gas pipe 63. The air electrode off-gas that has not been used for the electrochemical reaction (power generation) in the air electrode of each unit cell is directly supplied to the combustor 22. The fuel electrode off-gas introduced into the combustor 22 is combustible gas containing hydrogen, is mixed with the air electrode off-gas containing oxygen introduced into the combustor 22, and the mixed gas is combusted in the combustor 22, so that the fuel cell stack 21 is maintained at an appropriate temperature by combustion heat. The combustor 22 includes an ignition device 22f for igniting the mixed gas of fuel gas and air introduced into the combustor 22 in a start-up process. In the combustor 22, combustion exhaust gas is generated, and the combustion exhaust gas exchanges heat with air supplied from the air supply system 50 to the air electrode in the heat exchanger 24, and then is supplied to the exhaust heat recovery system 70 through a combustion exhaust gas pipe 72. The exhaust heat of the combustion exhaust gas is recovered by the exhaust heat recovery system 70, and then the combustion exhaust gas is discharged to the outside air.

The fuel supply system 40 includes a hydrogen supply pipe 31 having one end connected to a hydrogen supply source such as a hydrogen tank, a branch pipe 41 branching from the other end of the hydrogen supply pipe 31 to each power generation module 20, and a hydrogen blower 42 disposed in each branch pipe 41. By operating the hydrogen blower 42, the hydrogen gas in a hydrogen tank 2 is pumped (supplied) to the power generation module 20. Since the hydrogen blower 42 is disposed in each branch pipe 41, the supply amount of the hydrogen gas can be controlled for each power generation module 20 by individually controlling each hydrogen blower 42. An on-off valve 32 (dual valve), a negative pressure preventing valve (not illustrated), and the like are arranged in the hydrogen supply pipe 31, and a zero governor 43 (equalizer valve), a flow rate sensor 44, and the like are arranged in each branch pipe 41 in addition to the hydrogen blower 42. The flow rate sensor 44 detects the flow rate (fuel flow rate Fg) of hydrogen gas (fuel gas) flowing through the branch pipe 41 per unit time. The hydrogen gas introduced into the power generation module 20 is increased in temperature by heat exchange with the fuel electrode off-gas in the heat exchanger 23, and then supplied to the fuel electrode of the fuel cell stack 21.

The air supply system 50 includes an air supply pipe 51 connected to each power generation module 20, a filter 52 provided at an inlet of each air supply pipe 51, and an air blower 53 disposed in each air supply pipe 51. By operating the air blower 53, air is sucked from the filter 52 and the sucked air is pumped (supplied) to the power generation module 20. Since the air blower 53 is disposed in each air supply pipe 51, the supply amount of air can be controlled for each power generation module 20 by individually controlling each air blower 53. A flow rate sensor 54 is disposed in each air supply pipe 51. The flow rate sensor 54 detects the flow rate (air flow rate Fa) of air flowing through the air supply pipe 51 per unit time.

Air introduced into the power generation module 20 is increased in temperature by heat exchange with combustion exhaust gas in the heat exchanger 24, and then supplied to the air electrode of the fuel cell stack 21.

The circulation system 60 includes the condenser 61 having individual heat exchange flow paths for the individual power generation modules 20, the fuel electrode off-gas pipe 62 having one end connected to each power generation module 20 (fuel electrode side of the fuel cell stack 21) and the other end connected to an inlet of each heat exchange flow path of the condenser 61, the fuel electrode off-gas pipe 63 having one end connected to an outlet of each heat exchange flow path of the condenser 61 and the other end connected to each power generation module 20 (combustor 22 side), a circulation pipe 64 connecting the condenser 61 and a heat utilizing apparatus, and a circulation pump 65 disposed in the circulation pipe 64. The fuel electrode off-gas discharged from the fuel electrode side of the fuel cell stack 21 is supplied to the combustor 22 after water vapor contained in the fuel electrode off-gas is removed by the condenser 61 through heat exchange with a heat exchange medium circulating in the circulation pipe 64 by operating the circulation pump 65.

In addition, the circulation system 60 includes a reflux pipe 66 that branches from the fuel electrode off-gas pipe 63 on the downstream side of the condenser 61 and is connected between the hydrogen blower 42 and the zero governor 43 in the branch pipe 41 of the fuel supply system 40, and a regulating valve 67 (electromagnetic valve) disposed in the reflux pipe 66. By opening the regulating valve 67, part of the fuel electrode off-gas that has passed through the condenser 61 can be refluxed and supplied from the fuel supply system 40 to the power generation module 20. Note that an orifice may be provided in the reflux pipe 66 instead of the regulating valve 67.

The exhaust heat recovery system 70 includes a heat exchanger 71 connected to each combustion exhaust gas pipe 72, a heat storage tank 73, a circulation pipe 74 connecting the heat exchanger 71 and the heat storage tank 73, and a circulation pump 75 disposed in the circulation pipe 74. By operating the circulation pump 75, the combustion exhaust gas supplied to the heat exchanger 71 exchanges heat with a heat exchange fluid in the heat storage tank 73, and the exhaust heat of the combustion exhaust gas is recovered in the heat storage tank 73. The exhaust heat recovery system 70 also includes a circulation pipe 76 connecting the heat storage tank 73 and a heat utilizing apparatus installed in a plant or the like, and a circulation pump 77 disposed in the circulation pipe 76. By operating the circulation pump 77, the heat recovered in the heat storage tank 73 can be supplied to the heat utilizing apparatus.

The fuel cell stack 21 included in each of the plurality of power generation units 11 is connected in series to a single power conditioner 15, and the DC power generated in each fuel cell stack 21 is converted by the power conditioner 15 and supplied to a load L. A voltage sensor 91 for detecting the output voltage of the fuel cell stack 21 is disposed between the output terminals of the fuel cell stack 21 in each power generation module 20. A voltage sensor 92 for detecting the voltage (total voltage Vt) of the entire fuel cell stacks 21 is disposed between one terminal (fuel electrode terminal) of the fuel cell stack 21 disposed at one end among the fuel cell stacks 21 connected in series and the other terminal (air electrode terminal) of the fuel cell stack 21 disposed at the other end. A current sensor 93 that detects a current flowing through a power line connecting the fuel cell stacks 21 in series is disposed in the power line.

The power conditioner 15 includes a DC/DC converter and an inverter, converts DC power from each fuel cell stack 21 into AC power having a voltage (for example, AC 200 V) communicable with a system power supply, and outputs the AC power. A power supply board (not illustrated) is connected to the power conditioner 15. The power supply board converts power from each fuel cell stack 21 into DC power suitable for driving the various auxiliary machines 30, the module control device 90, and the integrated control device 100, and supplies the DC power to each of them. A cooling fan for cooling the power conditioner 15 and the power supply board and a ventilation fan (both not illustrated) are arranged in an auxiliary machine chamber in which the power conditioner 15, the power supply board, and the like are arranged.

Although not illustrated, each module control device 90 is configured as a microprocessor centered on a CPU, and includes a ROM storing a processing program, a RAM temporarily storing data, an input and output port, and a communication port in addition to the CPU. A stack temperature Tst from the temperature sensor 94 disposed near the corresponding fuel cell stack 21, a voltage V from the voltage sensor 91 disposed between the output terminals of the corresponding fuel cell stack 21, a fuel flow rate Fg from the flow rate sensor 44 disposed in the corresponding branch pipe 41 of the fuel supply system 40, an air flow rate Fa from the flow rate sensor 54 disposed in the corresponding air supply pipe 51 of the air supply system 50, and the like are input to each module control device 90 via the input port. In addition, a control signal to the corresponding hydrogen blower 42 of the fuel supply system 40, a control signal to the corresponding air blower 53 of the air supply system 50, a control signal to the corresponding regulating valve 67 of the circulation system 60, and the like are output from each module control device 90 via the output port.

The integrated control device 100 is configured as a microprocessor centered on a CPU 101, and includes a ROM 102 storing a processing program, a RAM 103 temporarily storing data, an EEPROM 104 as a nonvolatile memory, a timer (not illustrated), an input and output port, and a communication port in addition to the CPU 101. The total voltage Vt detected by the voltage sensor 92, a current I from the current sensor 93, and the like are input to the integrated control device 100 via the input port. In addition, a control signal to the on-off valve 32, a control signal to the circulation pump 65 of the circulation system 60, a control signal to the circulation pumps 75 and 77 of the exhaust heat recovery system 70, and the like are output from the integrated control device 100 via the output port. The integrated control device 100 is communicably connected to each module control device 90 via a communication bus 12, and exchanges control signals and data with each other.

Next, an operation of the fuel cell system 10 configured as described above according to the present embodiment will be described. When the start-up of the fuel cell system 10 is requested from the host system, each module control device 90 performs the start-up process in response to an instruction from the integrated control device 100. In the start-up process, each module control device 90 sequentially controls the auxiliary machine 30 to perform a purge process and the like of the combustor 22, then supplies fuel gas (hydrogen gas) and air to the combustor 22, and performs a warm-up process of warming up the fuel cell stack 21 by combusting the fuel gas in the combustor 22. When warm-up of each fuel cell stack 21 is completed and the fuel cell stack reaches a power generatable state, each module control device 90 shifts to a power generation process in response to an instruction from the integrated control device 100. The individual fuel cell stacks 21 of the individual power generation modules 20 are connected in series to the load L, and the current flows through all the fuel cell stacks 21 by the start of current sweep. For this reason, it is necessary to simultaneously start the power generation. Therefore, the shift to the power generation process is performed after all the fuel cell stacks 21 complete the warm-up and reach the power generatable state.

In the power generation process, each module control device 90 inputs a target fuel flow rate Fgtag and a target air flow rate Fatag set by the integrated control device 100 on the basis of requested power required for the entire fuel cell system 10, and controls the corresponding hydrogen blower 42 and air blower 53 on the basis of each input target flow rate. Specifically, each module control device 90 drives and controls the hydrogen blower 42 by feedback control on the basis of the difference between the target fuel flow rate Fgtag and the fuel flow rate Fg detected by the flow rate sensor 44, and drives and controls the air blower 53 by feedback control on the basis of the difference between the target air flow rate Fatag and the air flow rate Fa detected by the flow rate sensor 54.

When the stop of the fuel cell system 10 is requested, each module control device 90 performs a stop process in response to an instruction from the integrated control device 100. In the stop process, each module control device 90 controls the hydrogen blower 42 in a manner that the fuel gas is supplied at a flow rate that does not cause oxidation degradation of the electrode of the fuel cell stack 21, and controls the air blower 53 in a manner that air is supplied at a flow rate necessary for cooling the fuel cell stack 21. When the stack temperature Tst from the temperature sensor 94 decreases to a temperature lower than a predetermined temperature, each module control device 90 stops the supply of the fuel gas and the air.

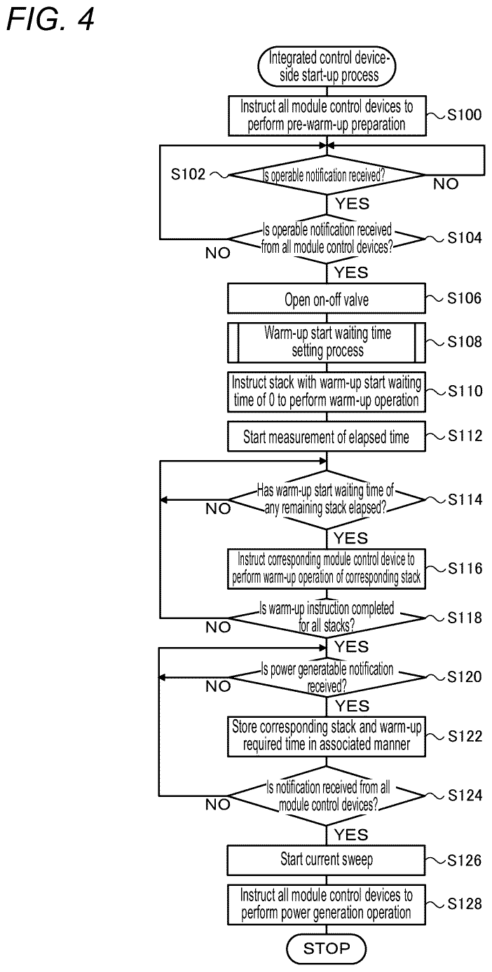

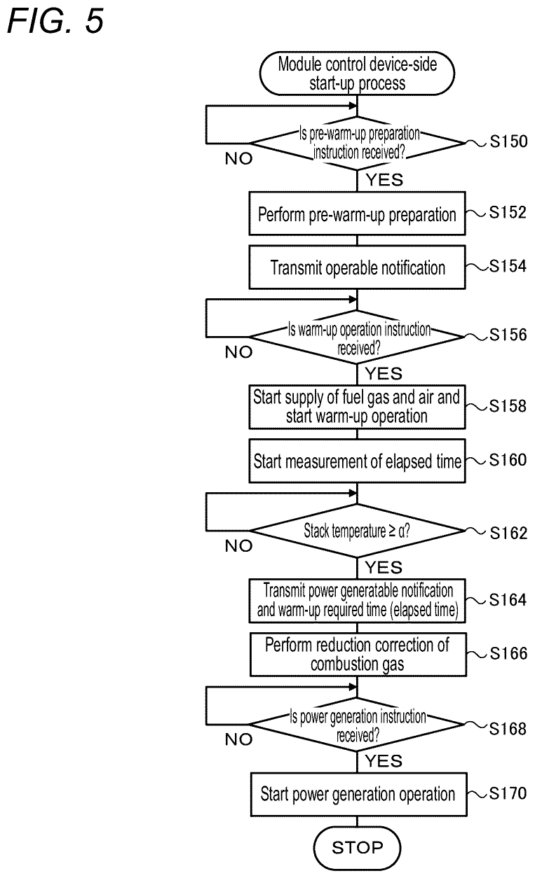

Next, details of the start-up process will be described. FIG. 4 is a flowchart illustrating an example of an integrated control device-side start-up process performed by the integrated control device 100, and FIG. 5 is a flowchart illustrating an example of a module control device-side start-up process performed by each module control device 90. These processes are performed when the start-up of the fuel cell system 10 is requested from the host system.

When the integrated control device-side start-up process is performed, the integrated control device 100 (CPU 101) first instructs all the module control devices 90 to perform a pre-warm-up preparation (step S100). In the module control device-side start-up process, when receiving a pre-warm-up preparation instruction from the integrated control device 100 (“YES” in step S150), as the pre-warm-up preparation, each module control device 90 checks whether or not the various auxiliary machines 30 and various sensors of the corresponding power generation unit 11 normally operate and whether or not the temperature (stack temperature Tst) of the fuel cell stack 21 is within an appropriate range (step S152), and then transmits a notification (operable notification) that the operation is enabled to the integrated control device 100 (step S154), and the process proceeds to step S156.

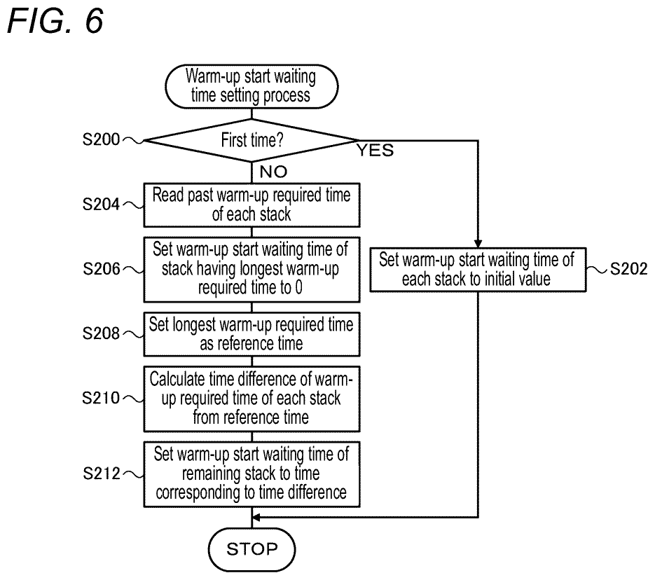

The integrated control device 100 determines whether or not the operable notification is received from each module control device 90 (step S102). When determining that the operable notification is not received, the integrated control device 100 returns to step S102 and repeats the reception determination. On the other hand, when determining that the operable notification is received, the integrated control device 100 determines whether or not the operable notification is received from all the module control devices 90 (step S104). When determining that the operable notification is not received from any of the module control devices 90, the integrated control device 100 returns to step S102. On the other hand, when determining that the operable notification is received from all the module control devices 90, the integrated control device 100 opens the on-off valve 32 (step S106) to enable fuel gas (hydrogen) to be supplied to each fuel cell stack 21. Subsequently, the integrated control device 100 sets a warm-up start waiting time for each fuel cell stack 21 (step S108). The warm-up start waiting time is set by the integrated control device 100 performing a warm-up start waiting time setting process illustrated in FIG. 6. The warm-up start waiting time setting process will be described later. The integrated control device 100 then instructs the corresponding module control device 90 to perform the warm-up operation of the fuel cell stack 21 with a warm-up start waiting time of 0 (step S110), and starts the measurement of the elapsed time (step S112). Next, on the basis of the elapsed period and the warm-up start waiting time set in each fuel cell stack 21, the integrated control device 100 determines whether or not the warm-up start waiting time of any remaining fuel cell stack 21 that has not been instructed to perform the warm-up operation has elapsed (step S114). When determining that the warm-up start waiting time has not elapsed in any of the remaining fuel cell stacks 21, the integrated control device 100 returns to step S114. On the other hand, when determining that the warm-up start waiting time has elapsed in any of the remaining fuel cell stacks 21, the integrated control device 100 instructs the corresponding module control device 90 to perform the warm-up operation of the corresponding fuel cell stack 21 (step S116).

The integrated control device 100 then determines whether or not to complete the warm-up operation instruction for all the fuel cell stacks 21 (step S118). If it is determined that the integrated control device 100 has not completed the warm-up operation instruction for any of the fuel cell stacks 21, the integrated control device 100 returns to step S114. On the other hand, if it is determined that the integrated control device 100 has completed the warm-up operation instruction for all the fuel cell stacks 21, the integrated control device 100 proceeds to step S120.

Each module control device 90 waits for receiving the warm-up operation instruction from the integrated control device 100 (step S156). When determining that the warm-up operation instruction is received, each module control device 90 starts the warm-up operation (step S158) and starts the measurement of the elapsed time (step S160). The warm-up operation is performed by controlling the hydrogen blower 42 and the air blower 53 in a manner that fuel gas (hydrogen) and air are supplied to the fuel cell stack 21 (combustor 22) at a fuel concentration within a combustion range, then driving the igniter of the ignition device 22f to burn the fuel gas in the combustor 22, and continuously supplying the fuel gas and air until the warm-up of the fuel cell stack 21 is completed and the fuel cell stack reaches the power generatable state. The supply amount control of the fuel gas during the warm-up operation is executed, for example, by setting the target fuel flow rate Fgtag at each of a plurality of timings (sequences) from the start to the completion of the warm-up operation and controlling the hydrogen blower 42 in a manner that the fuel flow rate Fg from the flow rate sensor 44 matches the target fuel flow rate Fgtag at that time. Each module control device 90 then determines whether or not the stack temperature Tst from the corresponding temperature sensor 94 is equal to or higher than a threshold a (step S162). Here, the threshold a is a threshold for determining whether or not the fuel cell stack 21 has completed the warm-up. When determining that the stack temperature Tst is not equal to or higher than the threshold a, each module control device 90 determines that the corresponding fuel cell stack has not reached the power generatable state, and the process returns to step S162. On the other hand, when determining that the stack temperature Tst is equal to or higher than the threshold a, each module control device 90 determines that the corresponding fuel cell stack has completed the warm-up and has reached the power generatable state, and transmits a notification (power generatable notification) that power generation is enabled and the elapsed time (warm-up required time) from the start of the warm-up operation to the integrated control device 100 (step S164). Note that, in addition to the determination as to whether the stack temperature Tst is equal to or higher than the threshold a, the determination as to whether the open circuit voltage OCV is equal to or higher than a threshold may also be made as to whether the corresponding fuel cell stack has reached the power generatable state. When the corresponding fuel cell stack 21 reaches the power generatable state, each module control device 90 performs the reduction correction of reducing the supply amount of the fuel gas (step S166), and waits for a power generation instruction from the integrated control device 100 (step S168). The fuel gas reduction correction is performed within a range in which combustion in the combustor 22 is maintained and the temperature of the fuel cell stack 21 does not fall below an appropriate temperature. As a result, it is possible to suppress wasteful fuel consumption as compared with a case where the same supply amount of fuel gas as that before reaching the power generatable state is supplied even after the corresponding fuel cell stack 21 reaches the power generatable state.

After giving the warm-up operation instruction in steps S110 to S118, the integrated control device 100 waits for the power generatable notification from any of the module control devices 90 (step S120). When determining that the power generatable notification is received, the integrated control device 100 stores the warm-up required time received together with the power generatable notification in the EEPROM 104 in association with the corresponding fuel cell stack 21 (step S122). The integrated control device 100 then determines whether or not the power generatable notification is received from all the module control devices 90 (step S124). When determining that the power generatable notification is not received from any of the module control devices 90, the integrated control device 100 returns to step S120 and repeats the processes in steps S120 to S124. On the other hand, when determining that the power generatable notification is received from all the module control devices 90, the integrated control device 100 controls the power conditioner 15 to start current sweep (step S126), instructs all the module control devices 90 to start the power generation operation (step S128), and ends the integrated control device-side start-up process. On the other hand, after transmitting the power generatable notification to the integrated control device 100, each module control device 90 waits for the power generation operation instruction from the integrated control device 100 (step S168). When determining that the power generation operation instruction is received, each module control device 90 starts the power generation operation (step S170), and ends the module control device-side start-up process. Note that details of the control of the power generation operation have been described above.

Next, the warm-up start waiting time setting process in FIG. 6 performed in step S108 of the integrated control device-side start-up process will be described. In the warm-up start waiting time setting process, the integrated control device 100 first determines whether or not the current start-up of the fuel cell system 10 is the first time (step S200). When determining that the current start-up is the first time, the integrated control device 100 sets the warm-up start waiting time of each fuel cell stack 21 to an initial value (step S202), and ends the warm-up start waiting time setting process. In the present embodiment, the initial value is determined for each fuel cell stack 21 and stored in advance in the EEPROM 104. For example, a warm-up start waiting time experimentally obtained so as to complete the warm-up of each fuel cell stack 21 at the same timing is set as the initial value. Note that the initial value may be set to 0 in any fuel cell stack 21.

On the other hand, when determining that the current start-up is not the first time, the integrated control device 100 reads the past warm-up required time for each fuel cell stack 21 from the EEPROM 104 (step S204). The warm-up required time read from the EEPROM 104 may be an average value of the warm-up required times in a case where the system has started up a plurality of times in the past, or may be the warm-up required time when the system has started up most recently. Next, the integrated control device 100 sets the warm-up start waiting time of the fuel cell stack 21 having the longest warm-up required time to 0 (step S206). Subsequently, the integrated control device 100 sets the longest warm-up required time as the reference time (step S208), and calculates the time difference of the warm-up required time of each of the remaining fuel cell stacks 21 from the reference time (step S210). The integrated control device 100 then sets the warm-up start waiting time of each of the remaining fuel cell stacks 21 to the time corresponding to the corresponding time difference (step S212), and ends the warm-up start waiting time setting process. Here, the warm-up start waiting time may be set by directly setting the time difference as the warm-up start waiting time, or by setting a time obtained by multiplying the time difference by a coefficient larger than 0 and smaller than 1 as the warm-up start waiting time.

As described above, by shifting the timing of start of the warm-up in the plurality of fuel cell stacks 21, all the fuel cell stacks 21 can complete the warm-up at the same timing and reach the power generatable state.

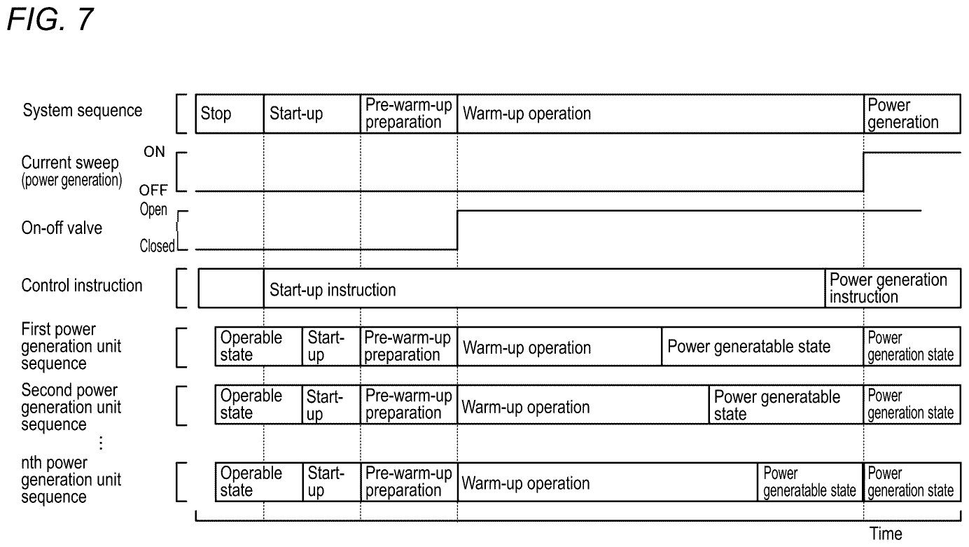

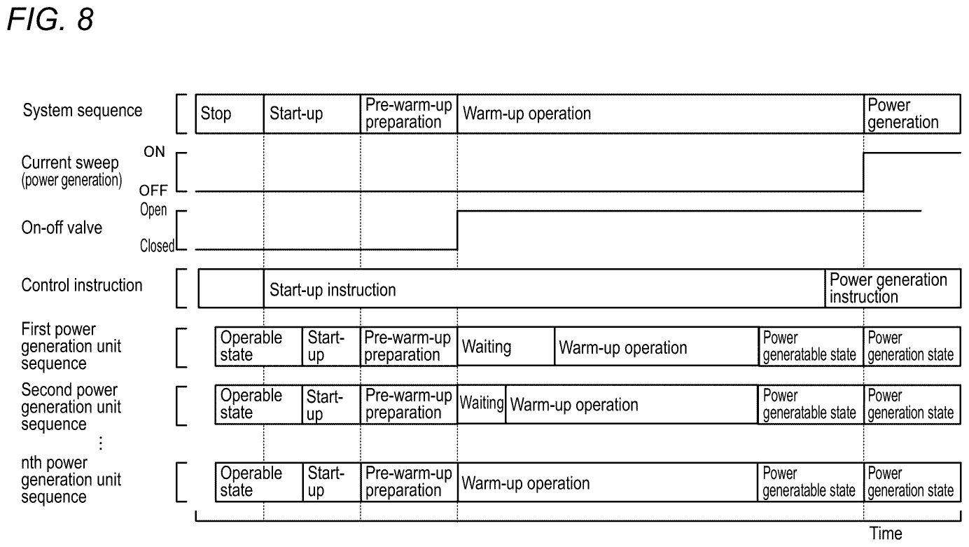

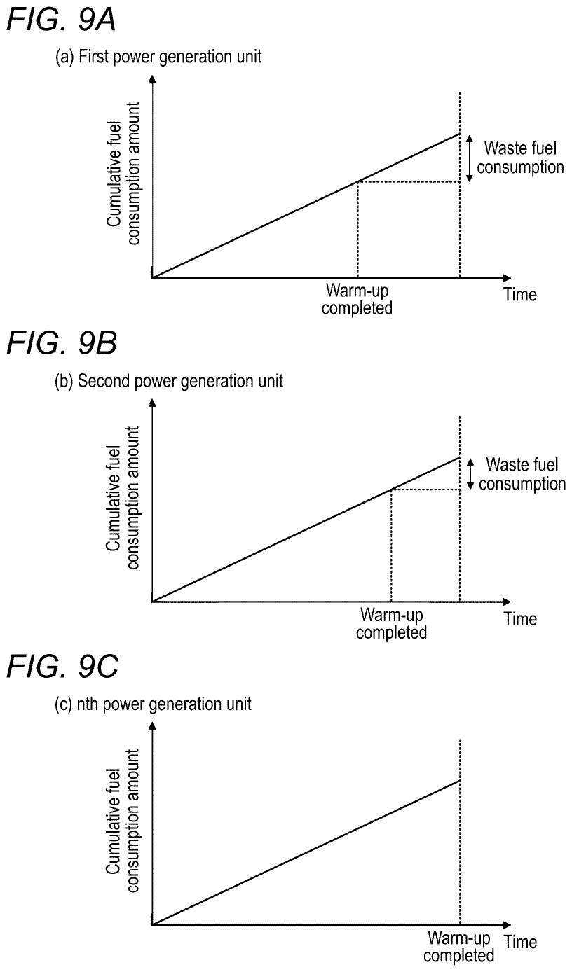

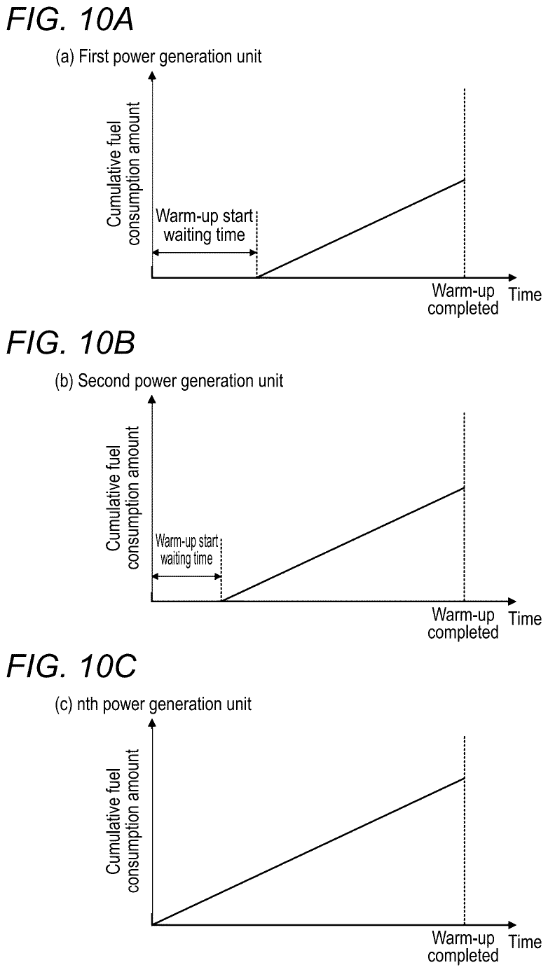

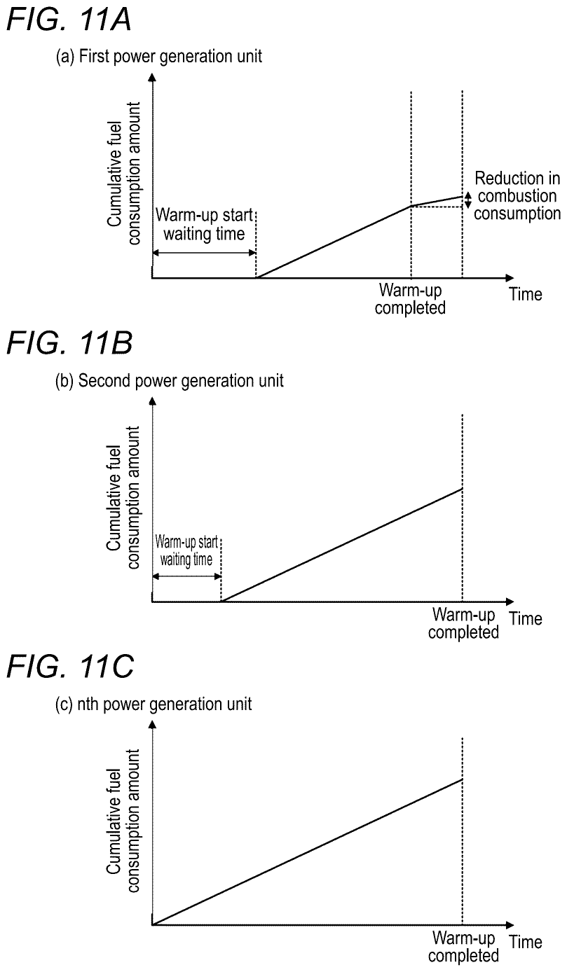

FIG. 7 is an explanatory diagram illustrating a state of a temporal change in each power generation unit sequence in a comparative example, and FIG. 8 is an explanatory diagram illustrating a state of a temporal change in each power generation unit sequence in the present embodiment. FIG. 9 is an explanatory diagram illustrating the cumulative fuel consumption amount during the warm-up operation of each power generation unit in the comparative example, FIG. 10 is an explanatory diagram illustrating the cumulative fuel consumption amount during the warm-up operation of each power generation unit in the present embodiment, and FIG. 11 is an explanatory diagram illustrating the cumulative fuel consumption amount in a case where the combustion supply amount of a power generation unit that has completed warm-up before other units is reduced. Here, in the comparative example, as illustrated in FIG. 7, the integrated control device 100 simultaneously instructs all the module control devices 90 to start warm-up so that the warm-up operation is simultaneously started in all the fuel cell stacks 21, which are connected in series, in n power generation units 11 (first, second, . . . nth power generation units). On the other hand, in the present embodiment, as illustrated in FIG. 8, the integrated control device 100 instructs each module control device 90 to start the warm-up at different timings so that all the fuel cell stacks 21 simultaneously complete the warm-up operation and reach the power generatable state. The fuel cell system 10 of the present embodiment includes n power generation units 11, and the installation position of the fuel cell stack 21, the tolerance of the auxiliary machine 30, and the degree of degradation of the fuel cell stack 21 differ for each power generation unit 11, so that the progress of the warm-up (rising speed of the stack temperature Tst) varies for each fuel cell stack 21. Therefore, even if the warm-up operation is simultaneously started in all the fuel cell stacks 21, the warm-up may not be completed simultaneously. In this case, in a fuel cell stack 21 that has completed the warm-up earlier and has reached the power generatable state among the plurality of fuel cell stacks 21, as illustrated in FIG. 9, it is necessary to continuously supply the fuel gas (hydrogen) in order to maintain the power generatable state until the remaining fuel cell stacks 21 complete the warm-up and reach the power generatable state, and wasteful fuel consumption occurs. In addition, along with the supply of the fuel gas, wasteful power consumption also occurs due to driving of the hydrogen blower 42 and the like. Therefore, in the present embodiment, the integrated control device 100 sets the warm-up start waiting time in each fuel cell stack 21, and instructs the corresponding module control device 90 to start the warm-up operation at the timing when each warm-up start waiting time has elapsed. As a result, as illustrated in FIG. 10, the warm-up can be simultaneously completed in all the fuel cell stacks 21, and the occurrence of wasteful fuel consumption and power consumption can be suppressed. In the present embodiment, when some of the fuel cell stacks 21 complete the warm-up early even though the warm-up operation of each fuel cell stack 21 starts after each warm-up start waiting time, the reduction correction of reducing the supply amount of the fuel gas to the corresponding fuel cell stack 21 is performed (step S166 of the module control device-side start-up process), so that wasteful fuel consumption can be minimized (see FIG. 11).

In the fuel cell system 10 of the present embodiment described above, when all of the plurality of fuel cell stacks 21 connected in series reach the power generatable state, the current sweep is started to cause the plurality of fuel cell stacks 21 to simultaneously generate power. As a result, it is possible to prevent the current from being swept from some low-temperature fuel cell stacks 21 and to suppress the degradation of the fuel cell stacks 21. Furthermore, the timing of start of the warm-up operation of the plurality of fuel cell stacks 21 is adjusted in a manner that the plurality of fuel cell stacks 21 simultaneously reach the power generatable state. If the timings at which the plurality of fuel cell stacks 21 reach the power generatable state are shifted, wasteful fuel consumption for maintaining the power generatable state in the fuel cell stack 21 that has reached the power generatable state early occurs. In the present embodiment, by adjusting the timing of start of the warm-up operation of the plurality of fuel cell stacks 21, the plurality of fuel cell stacks 21 can reach the power generatable state simultaneously, and the occurrence of wasteful fuel consumption can be suppressed.

In addition, in the fuel cell system 10 of the present embodiment, the warm-up required time required for each of the plurality of fuel cell stacks 21 to reach the power generatable state at the time of the past start-up of the system is stored in the EEPROM 104, and the warm-up start waiting times of the plurality of fuel cell stacks 21 are set on the basis of the past warm-up required time in a manner that the plurality of fuel cell stacks 21 simultaneously reach the power generatable state when the system starts up next or later. As a result, in each fuel cell stack 21, the warm-up operation starts based on the warm-up start waiting time, so that the plurality of fuel cell stacks 21 can simultaneously reach the power generatable state more reliably. Furthermore, the initial value of the warm-up start waiting time of each fuel cell stack 21 is stored in advance in the EEPROM 104, and the initial value is set as the warm-up start waiting time when the system starts up for the first time. Therefore, even when the system starts up for the first time, the plurality of fuel cell stacks 21 can reach the power generatable state simultaneously.

Moreover, in the fuel cell system 10 of the present embodiment, the supply amount of the fuel gas to the fuel cell stack 21 that has completed the warm-up operation earlier among the plurality of fuel cell stacks 21 is reduced as compared with the supply amount of the fuel gas to the fuel cell stack 21 during the warm-up operation, so that wasteful fuel consumption can be suppressed.

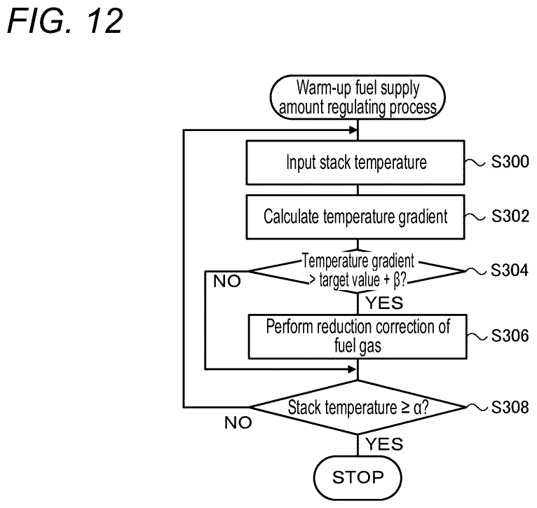

In the embodiment described above, in the warm-up operation, each module control device 90 supplies the fuel gas based on the target fuel flow rate Fgtag set in advance at a plurality of timings (sequences) from the start to the end of the warm-up operation. However, the supply amount of the fuel gas may be regulated by monitoring the temperature gradient (change amount per unit time of the stack temperature Tst) of the fuel cell stack 21 during the warm-up operation. FIG. 12 is a flowchart illustrating an example of a warm-up fuel supply amount regulating process. This process is performed by each module control device 90 when each of the plurality of timings (sequences) arrives after the warm-up operation starts.

In the warm-up fuel supply amount regulating process, each module control device 90 inputs the stack temperature Tst from the temperature sensor 94 (step S300), and calculates a temperature gradient by taking the difference between the stack temperature Tst input this time and the stack temperature input last time (step S302). Each module control device 90 then determines whether or not the calculated temperature gradient is larger than a threshold obtained by adding a slight margin value β to a target gradient (step S304). Here, the target gradient is a temperature gradient necessary for completing the warm-up of the fuel cell stack 21 at a target timing. When determining that the temperature gradient is larger than the threshold, each module control device 90 performs the reduction correction of reducing the supply amount of the fuel gas (target fuel flow rate Fgtag) (step S306). On the other hand, when determining that the temperature gradient is equal to or less than the threshold, each module control device 90 skips step S306. Each module control device 90 then determines whether or not the stack temperature Tst is equal to or higher than the threshold a, that is, whether or not the warm-up of the fuel cell stack 21 is completed (step S308). When determining that the warm-up is not completed, each module control device 90 returns to step S300 and repeats the processes in steps S300 to S308, and when determining that the warm-up is completed, the warm-up fuel supply amount regulating process ends. As a result, the temperature (stack temperature Tst) of each fuel cell stack 21 can rise based on each target gradient. Note that in a case where the temperature gradient is smaller than a threshold obtained by subtracting the margin value β from the target gradient, each module control device 90 may perform the increase correction of increasing the supply amount of the fuel gas (target fuel flow rate Fgtag) within a range not exceeding the upper limit amount.

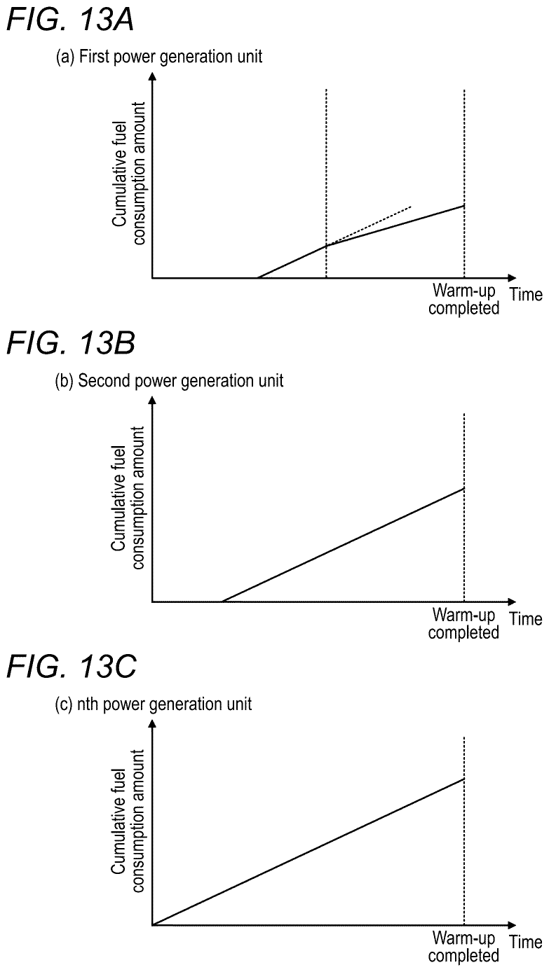

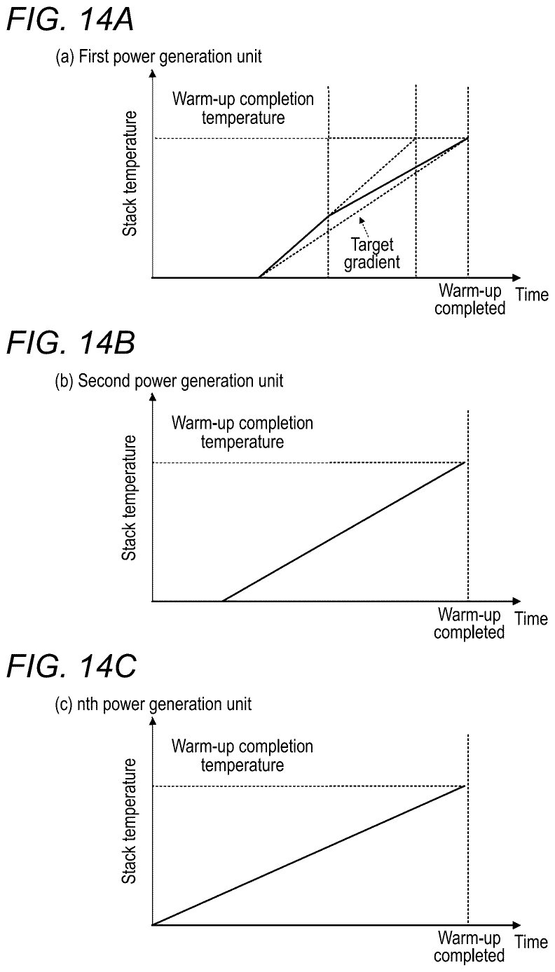

FIG. 13 is an explanatory diagram illustrating the cumulative fuel consumption amount when the warm-up operation is performed based on a target gradient in each power generation unit 11, and FIG. 14 is an explanatory diagram illustrating a state of a change in stack temperature when the warm-up operation is performed based on the target gradient in each power generation unit. When the temperature gradient of the corresponding fuel cell stack 21 deviates from the target gradient, the module control device 90 regulates the supply amount of the fuel gas (target fuel flow rate Fgtag) in a manner that the temperature gradient approaches the target gradient. As a result, it is possible to simultaneously complete the warm-up of all the fuel cell stacks 21 and to suppress wasteful fuel consumption.

Note that each module control device 90 may set the target temperature of the fuel cell stack 21 stepwise at a plurality of timings (sequences) from the start to the completion of the warm-up operation, set the target fuel flow rate Fgtag in a manner that the stack temperature Tst matches the target temperature at that time, and control the hydrogen blower 42, thereby simultaneously completing the warm-up of all the fuel cell stacks 21.

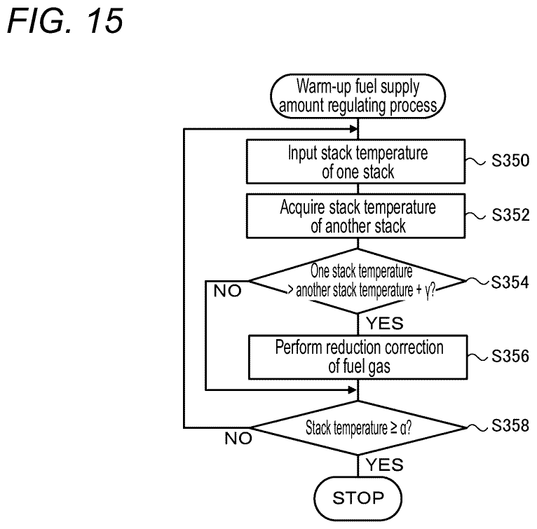

Furthermore, the supply amount of the fuel gas to the fuel cell stack 21 in which the warm-up progresses among the plurality of fuel cell stacks 21 may be reduced as compared with the supply amount of the fuel gas to the fuel cell stack in which the warm-up delays. FIG. 15 is a flowchart illustrating an example of the warm-up fuel supply amount regulating process. In the warm-up fuel supply amount regulating process, each module control device 90 inputs the stack temperature Tst (one stack temperature) in one fuel cell stack 21 (one stack) from the temperature sensor 94 (step S350), and acquires the stack temperature Tst (the other stack temperature) in another fuel cell stack 21 (another stack) (step S352). The another stack temperature can be acquired through communication from the module control device 90 that inputs the stack temperature Tst from the temperature sensor 94 provided in another stack via the integrated control device 100. Each module control device 90 then determines whether or not the one stack temperature is higher than a threshold obtained by adding a slight margin value y to the another stack temperature (step S354). When determining that the one stack temperature is higher than the threshold, each module control device 90 performs the reduction correction of reducing the supply amount of the fuel gas (target fuel flow rate Fgtag) (step S356). On the other hand, when determining that the one stack temperature is equal to or lower than the threshold, each module control device 90 skips step S356. Each module control device 90 then determines whether or not the stack temperature Tst is equal to or higher than the threshold a, that is, whether or not the warm-up of the fuel cell stack 21 is completed (step S358). When determining that the warm-up is not completed, each module control device 90 returns to step S350 and repeats the processes in steps S350 to S358, and when determining that the warm-up is completed, the warm-up fuel supply amount regulating process ends. As a result, the one stack temperature can be made to match the another stack temperature, and the warm-up of all the fuel cell stacks 21 can be completed simultaneously. Note that each module control device 90 may perform the increase correction of increasing the supply amount of the fuel gas to the fuel cell stack 21 in which the warm-up delays among the plurality of fuel cell stacks 21 as compared with the supply amount of the fuel gas to the fuel cell stack in which the warm-up progresses within a range not exceeding the upper limit amount.

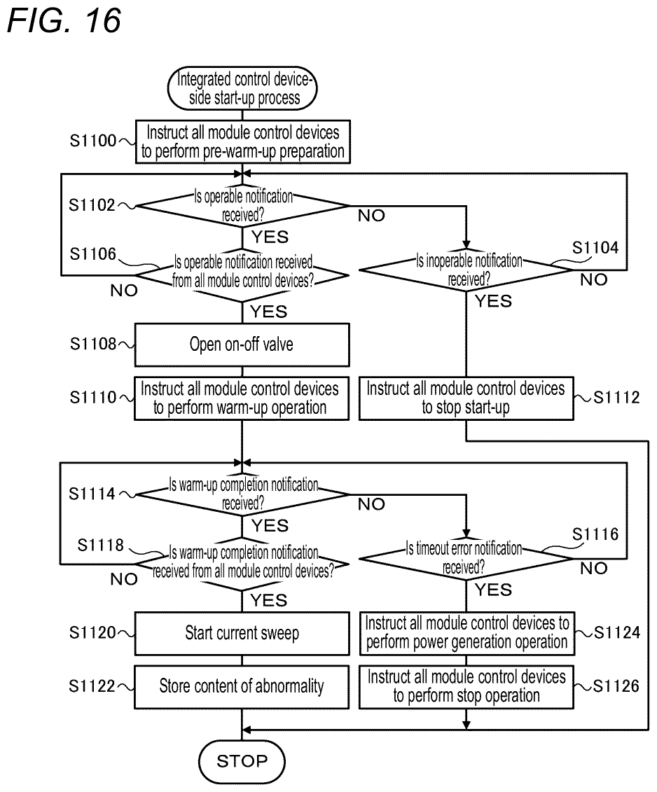

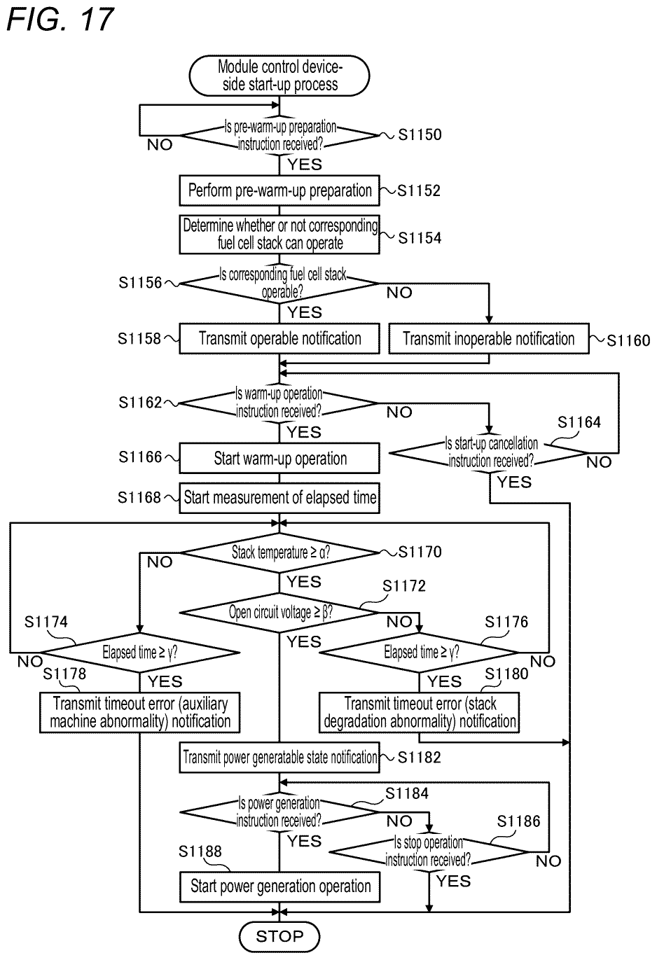

Next, details of a start-up process according to another embodiment will be described. FIG. 16 is a flowchart illustrating an example of an integrated control device-side start-up process performed by the integrated control device 100, and FIG. 17 is a flowchart illustrating an example of a module control device-side start-up process performed by each module control device 90. These processes are performed when the start-up of the system is requested from the host system.

In the integrated control device-side start-up process, the integrated control device 100 (CPU 101) first instructs all the module control devices 90 to perform a pre-warm-up preparation (step S1100). On the other hand, in the module control device-side start-up process, each module control device 90 waits for a pre-warm-up preparation instruction from the integrated control device 100 (step S1150). Subsequently, as the pre-warm-up preparation, each module control device 90 checks whether or not various auxiliary machines 30 and various sensors of the corresponding power generation unit 11 normally operate, and checks whether or not the temperature (stack temperature Tst) of the fuel cell stack 21 is within an appropriate range (step S1152), and determines whether or not the corresponding fuel cell stack 21 can operate (step S1154). When determining that the corresponding fuel cell stack 21 can operate (“YES” in step S1156), each module control device 90 transmits a notification that the operation is enabled (operable notification) to the integrated control device 100 (step S1158), and the process proceeds to step S1162. On the other hand, when determining that the corresponding fuel cell stack 21 cannot operate (“NO” in step S1156), each module control device 90 transmits a notification that the operation is not enabled (inoperable notification) to the integrated control device 100 (step S1160), and the process proceeds to step S1162.

The integrated control device 100 determines whether or not the operable notification is received from each module control device 90 (step S1102) and whether or not the inoperable notification is received (step S1104). When determining that no notification is received, the integrated control device 100 returns to step S1102 and repeats the reception determination. On the other hand, when determining that the operable notification is received, the integrated control device 100 determines whether or not the operable notification is received from all the module control devices 90 (step S1106). When determining that the operable notification is not received from any of the module control devices 90, the integrated control device 100 returns to step S1102. On the other hand, when determining that the operable notification is received from all the module control devices 90, the integrated control device 100 opens the on-off valve 32 (step S1108) to enable fuel gas (hydrogen) to be supplied to each fuel cell stack 21, instructs all the module control devices 90 to perform the warm-up operation (step S1110), and proceeds to step S1114. On the other hand, when determining that the inoperable notification is received from any of the module control devices 90 in step S1104, the integrated control device 100 instructs all the module control devices 90 to cancel the start-up (step S1112), and ends the integrated control device-side start-up process. Each module control device 90 determines whether or not the warm-up operation instruction is received from the integrated control device 100 (step S1162) and whether or not the start-up cancellation instruction is received (step S1164). When determining that no instruction is received, each module control device 90 returns to step S1162 and repeats the reception determination. When determining that the start-up cancellation instruction is received, each module control device 90 ends the module control device-side start-up process without performing the warm-up operation. On the other hand, when determining that the warm-up operation instruction is received, each module control device 90 starts the warm-up operation (step S1166) and starts the measurement of the elapsed time (step S1168). The warm-up operation is performed by controlling the hydrogen blower 42 and the air blower 53 in a manner that fuel gas (hydrogen) and air are supplied to the fuel cell stack 21 (combustor 22) at a fuel concentration within a combustion range, then driving the igniter of the ignition device 22f to burn the fuel gas in the combustor 22, and continuously supplying the fuel gas and air until the warm-up of the fuel cell stack 21 is completed and the fuel cell stack reaches the power generatable state.

Each module control device 90 then determines whether or not the stack temperature Tst from the corresponding temperature sensor 94 is equal to or higher than the threshold α (step S1170), and whether or not the voltage (open circuit voltage OCV) from the corresponding voltage sensor 91 is equal to or higher than the threshold β (step S1172). Here, the thresholds α and β are thresholds for determining whether or not the fuel cell stack 21 is in a power generatable state. When determining that the stack temperature Tst is not equal to or higher than the threshold α or determining that the open circuit voltage OCV is not equal to or higher than the threshold β even if the stack temperature Tst is equal to or higher than the threshold a, each module control device 90 determines whether or not the elapsed time from the start of the warm-up operation is equal to or longer than the threshold γ (steps S1174 and S1176). Here, the threshold γ is set to be longer than the time normally required to complete the warm-up of the fuel cell stack 21. When determining that the elapsed time is not equal to or longer than the threshold γ, each module control device 90 returns to step S1170. When determining that the stack temperature Tst is equal to or higher than the threshold a and the open circuit voltage OCV is equal to or higher than the threshold β, each module control device 90 determines that the warm-up operation of the fuel cell stack 21 is normally completed, transmits a notification (power generatable notification) that power generation is enabled to the integrated control device 100 (step S1182), and proceeds to step S1184. On the other hand, when determining that the stack temperature Tst is not equal to or higher than the threshold a and determining that the elapsed time is equal to or longer than the threshold y, each module control device 90 determines that an abnormality has occurred in the auxiliary machine 30, transmits a notification (timeout error notification) that a timeout error has occurred to the integrated control device 100 together with the content of the abnormality and the identification information of the power generation module 20 in which the abnormality has occurred (step S1178), and ends the module control device-side start-up process. Furthermore, when determining that the stack temperature Tst is equal to or higher than the threshold α, determining that the open circuit voltage OCV is not equal to or higher than the threshold β, and determining that the elapsed time is equal to or longer than the threshold γ, each module control device 90 determines that the open circuit voltage OCV does not sufficiently rise and the fuel cell stack 21 is degraded, transmits a timeout error notification to the integrated control device 100 together with the content of the abnormality and the identification information of the power generation module 20 in which the abnormality has occurred (step S1180), and ends the module control device-side start-up process.

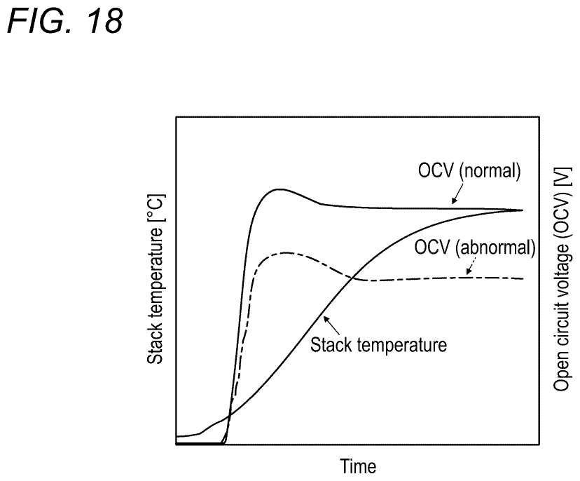

As illustrated in FIG. 18, when the warm-up of the fuel cell stack 21 starts and the stack temperature Tst starts to rise, the open circuit voltage OCV rapidly rises, and thereafter, as the warm-up progresses, the open circuit voltage OCV converges to a constant value and the stack temperature Tst gradually rises. When the degradation of the fuel cell stack 21 progresses, the open circuit voltage OCV is lower than a normal OCV. Therefore, the presence or absence of the degradation of the fuel cell stack 21 can be diagnosed by examining the open circuit voltage OCV at the timing when the elapsed time from the start of the warm-up operation becomes equal to or longer than the threshold γ (time longer than the time normally required to complete the warm-up).

After giving the warm-up operation instruction in step S1110, the integrated control device 100 determines whether or not the power generatable notification is received (step S1114) and whether or not the timeout error notification is received (step S1116) from any of the module control devices 90. When determining that no notification is received, the integrated control device 100 returns to step S1114 and repeats the reception determination. On the other hand, when determining that the power generatable notification is received, the integrated control device 100 determines whether or not the power generatable notification is received from all the module control devices 90 (step S1118). When determining that no power generatable notification is not received from any of the module control devices 90, the integrated control device 100 returns to step S1114. On the other hand, when determining that the power generatable notification is received from all the module control devices 90, the integrated control device 100 controls the power conditioner 15 to start current sweep (step S1120), instructs all the module control devices 90 to perform the power generation operation (step S1122), and ends the integrated control device-side start-up process. On the other hand, when determining that the timeout error notification is received from any of the module control devices 90, the integrated control device 100 stores the content of an abnormality and the identification information of the power generation module 20 in which the abnormality has occurred in the EEPROM 104 (step S1124), instructs all the module control devices 90 to perform a stop operation (step S1126), and ends the integrated control device-side start-up process. After transmitting the power generatable notification in step S1182, each module control device 90 determines whether or not the power generation operation instruction is received (step S1184) and whether or not the stop operation instruction is received (step S1186). When determining that no instruction is received, each module control device 90 returns to step S1184 and repeats the reception determination. On the other hand, when determining that the power generation operation instruction is received, each module control device 90 starts the power generation operation (step S1188), and ends the module control device-side start-up process. Note that details of the control of the power generation operation have been described above. When determining that the stop operation instruction is received, each module control device 90 ends the module control device-side start-up process. The stop operation is performed in a module control device-side stop process to be described later. The details of the start-up process have been described above.

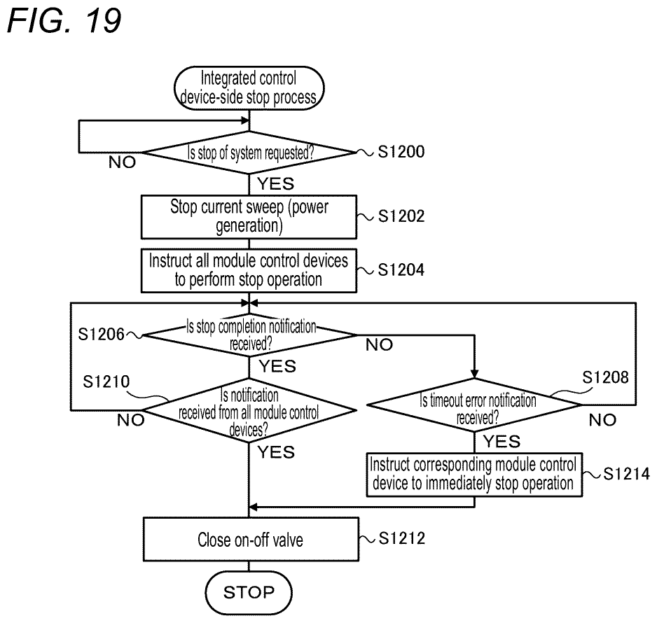

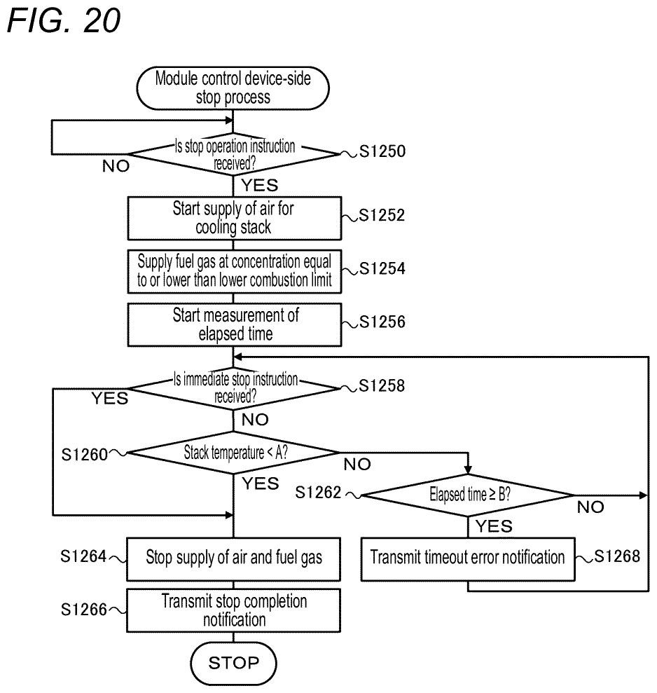

Next, details of the stop process will be described. FIG. 19 is a flowchart illustrating an example of an integrated control device-side stop process performed by the integrated control device 100, and FIG. 20 is a flowchart illustrating an example of a module control device-side stop process performed by each module control device 90.

In the integrated control device-side stop process, the integrated control device 100 (CPU 101) first waits for a system stop request from the host system (step S1200). When determining that the stop of the system is requested, the integrated control device 100 controls the power conditioner 15 to stop the current sweep from each fuel cell stack 21 (step S1202), and instructs all the module control devices 90 to perform the stop operation (step S1204). On the other hand, in the module control device-side stop process, when receiving the stop operation instruction from the integrated control device 100 (step S1250), each module control device 90 starts air supply at a predetermined flow rate necessary for cooling the corresponding fuel cell stack 21 (step S1252), and starts fuel gas supply at a flow rate at which the combustion zone of the combustor 22 has a concentration equal to or lower than the lower combustion limit (step S1252). Each module control device 90 then starts the measurement of the elapsed time (step S1256). Next, each module control device 90 determines whether or not an immediate stop instruction to be described later is received (step S1258), whether or not the stack temperature Tst is lower than a threshold A (step S1260), and whether or not the elapsed time is equal to or longer than a threshold B (step S1262). Here, the threshold A is set to a value near the lower limit value in the temperature range in which the catalytic oxidation of the fuel cell stack 21 progresses. The threshold B is set to be longer than the time normally required for the stack temperature Tst to fall below the threshold A in the stop operation. When determining that the immediate stop instruction is not received and determining that the stack temperature Tst is not less than the threshold A and the elapsed time is not equal to or longer than the threshold B, each module control device 90 returns to step S1258 and repeats the reception determination. On the other hand, when determining that the immediate stop instruction is not received and determining that the stack temperature Tst is lower than the threshold A, each module control device 90 determines that cooling of the fuel cell stack 21 is completed, stops the supply of the air and the fuel gas (step S1264), transmits a notification (stop completion notification) that the stop operation is completed to the integrated control device 100 (step S1266), and ends the module control device-side stop process. When determining that the immediate stop instruction is not received, and determining that the stack temperature Tst is not lower than the threshold A and the elapsed time is equal to or longer than the threshold B, each module control device 90 determines that the fuel cell stack 21 cannot be cooled and the system cannot be stopped by the normal stop operation, transmits a timeout error notification to the integrated control device 100 (step S1268), and returns to step S1258. As a case where the fuel cell stack 21 cannot be cooled, a case where the supply amount of air is insufficient or a case where the combustion of the combustor 22 is maintained due to an excessive supply amount of fuel gas is considered, and in either case, it is determined that there is a possibility that an abnormality occurs in the auxiliary machine 30.

After instructing all the module control devices 90 to perform the stop operation in step S1204, the integrated control device 100 determines whether or not the stop completion notification is received (step S1206) and whether or not the timeout error notification is received (step S1208) from any of the module control devices 90. When determining that no notification is received, the integrated control device 100 returns to step S1206 and repeats the reception determination. On the other hand, when determining that the stop completion notification is received, the integrated control device 100 determines whether or not the stop completion notification is received from all the module control devices 90 (step S1210). When determining that the stop completion notification is not received from any of the module control devices 90, the integrated control device 100 returns to step S1206. On the other hand, when determining that the stop completion notification is received from all the module control devices 90, the integrated control device 100 closes the on-off valve 32 (step S1212) and ends the integrated control device-side stop process. When determining that the timeout error notification is received from any of the module control devices 90, the integrated control device 100 transmits the immediate stop instruction to the module control device 90 that has transmitted the timeout error notification (step S1214), and ends the integrated control device-side stop process. Upon receiving the immediate stop instruction, the module control device 90 immediately stops the supply of air and fuel gas (step S1264), transmits the stop completion notification (step S1266), and ends the module control device-side stop process.

In the fuel cell system 10 of another embodiment described above, in which the fuel cell stacks 21 are connected in series between the plurality of power generation units 11, the integrated control device 100 starts the current sweep to instruct all the module control devices 90 to start the power generation operation of the corresponding fuel cell stack 21 on the basis of the reception of the notification (power generatable notification) that the power generation of the corresponding fuel cell stack 21 is enabled from all of the plurality of module control devices 90 in the start-up process. As a result, when the current sweep starts, it is possible to prevent an excessive current from flowing through a fuel cell stack 21 having a low temperature, and it is possible to more reliably suppress the degradation of the fuel cell stack 21.

Furthermore, in the fuel cell system 10 of another embodiment, in the start-up process, each module control device 90 determines whether or not the corresponding fuel cell stack 21 (power generation unit 11) can operate and transmits the determination result (operable notification or inoperable notification) to the integrated control device 100, and the integrated control device 100 instructs all the module control devices 90 to start the warm-up operation of the corresponding fuel cell stack 21 on the basis of the reception of the operable notification from all the module control devices 90. As a result, in a case where any of the plurality of fuel cell stacks 21 connected in series is not in the operable state, the start of the warm-up operation of another fuel cell stack 21 can be avoided.

Moreover, when the temperature (stack temperature Tst) of the corresponding fuel cell stack 21 is equal to or higher than the threshold α and the open circuit voltage OCV of the corresponding fuel cell stack 21 is equal to or higher than the threshold β before the elapsed time from the start of the warm-up operation reaches the threshold γ, each module control device 90 transmits the power generatable notification to the integrated control device 100. On the other hand, when the elapsed time from the start of the warm-up operation reaches the threshold γ before the stack temperature Tst becomes equal to or higher than the threshold α, each module control device 90 determines that the corresponding fuel cell stack 21 is degraded and transmits a timeout notification (timeout error notification) to the integrated control device 100, and when the elapsed time from the start of the warm-up operation reaches the threshold γ before the open circuit voltage OCV becomes equal to or higher than the threshold β, each module control device determines that an abnormality (system failure) has occurred in the auxiliary machine 30 and transmits the timeout error notification to the integrated control device 100. When receiving the timeout error notification from any of the module control devices 90, the integrated control device 100 instructs all the module control devices 90 to perform the stop operation. As a result, it is possible to prevent a current from being swept from a fuel cell stack 21 having a low temperature in which the warm-up operation is not completed or from a fuel cell stack 21 in which an abnormality has occurred in the auxiliary machine 30 among the plurality of fuel cell stacks 21 connected in series, and to suppress the failure of the fuel cell stack 21.

In addition, in the stop process, each module control device 90 performs the stop operation of supplying the fuel gas and air to the corresponding fuel cell stack 21 within the range equal to or lower than the lower combustion limit, transmits a notification (stop completion notification) that the supply of the fuel gas and air is stopped and the stop operation is completed to the integrated control device 100 on the basis of the fact that the temperature (stack temperature Tst) of the corresponding fuel cell stack 21 is lower than the threshold A, and transmits a notification (timeout error notification) that the stop operation is not completed to the integrated control device 100 when the elapsed time from the start of the stop operation reaches the threshold B before the stack temperature Tst becomes lower than the threshold A. When receiving the timeout error notification from any of the module control devices 90, the integrated control device 100 instructs the corresponding module control devices 90 to perform an immediate stop operation. Therefore, even in a case where any of the plurality of fuel cell stacks 21 connected in series cannot complete the stop operation, it is possible to appropriately handle such a case.

In the embodiment described above, the fuel supply system 40 supplies hydrogen gas as fuel gas to the fuel electrode of the fuel cell stack 21, but raw fuel gas such as natural gas or LP gas may be reformed into fuel gas containing hydrogen gas and supplied to the fuel electrode of the fuel cell stack 21. In this case, the fuel supply system may include a gas pump that pumps raw fuel gas to the branch pipe 41 and a desulfurizer that removes a sulfur component in the raw fuel gas, and may include an evaporator that receives supply of water (reformed water) and generates water vapor and a reformer that reforms the raw fuel gas into fuel gas using the water vapor from the evaporator in the module case 29.

In the embodiment described above, each fuel cell stack 21 performs the power generation operation of generating power by the reaction between hydrogen and oxygen contained in air. However, the fuel cell stack 21 is a reversibly operated solid oxide cell stack, and may include a FC mode in which the power generation operation is performed and an EC mode in which an electrolysis operation of generating hydrogen by high-temperature steam electrolysis in a state where power is supplied from a power supply is performed. Note that, as the power supply, a system power supply, renewable energy such as a solar power generator, a storage battery, or the like can be used.

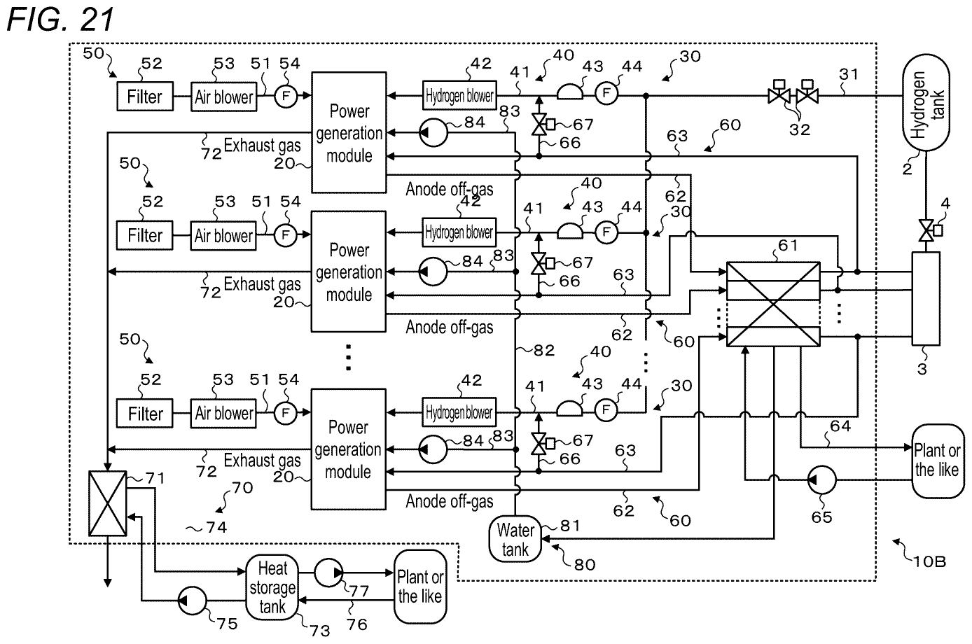

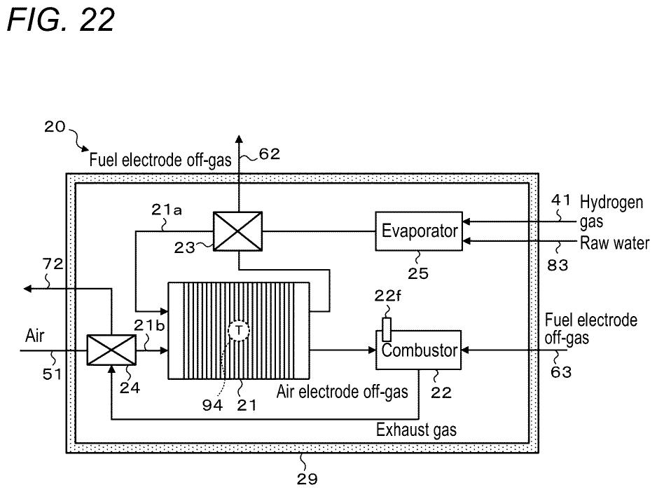

FIG. 21 is a schematic configuration diagram of a fuel cell system 10B according to another embodiment, and FIG. 22 is a schematic configuration diagram of a power generation module 20 thereof. In the fuel cell system 10B according to another embodiment, the power generation module 20 includes an evaporator 25 and the like in addition to the fuel cell stack 21, the combustor 22, and the heat exchangers 23 and 24, and these components are housed in the module case 29 with a heat insulating property. Note that the evaporator 25 may include a heater for compensating heat insufficient in the evaporator 25. The various auxiliary machines 30 include a water supply system 80, and the like in addition to the fuel supply system 40, the air supply system 50, the circulation system 60, and the exhaust heat recovery system 70.

The water supply system 80 includes a water tank 81 that stores water (raw water), a water supply pipe 82 having one end connected to the water tank 81, a branch pipe 83 that branches from the other end of the water supply pipe 82 to each power generation module 20, and a water pump 84 disposed in each branch pipe 83. By operating the water pump 84, the raw water in the water tank 81 is pumped (supplied) to the power generation module 20. Since the water pump 84 is disposed in each branch pipe 83, the supply amount of the raw water can be controlled for each power generation module 20 by individually controlling each water pump 84. The evaporator 25 is connected between the branch pipe 83 of the water supply system 80 and the fuel gas supply pipe 21a. The raw water is evaporated in the evaporator 25 to be converted into water vapor.

In the EC mode, water vapor and a small amount of hydrogen gas supplied as fuel gas by the water supply system 80 and the fuel supply system 40 are introduced into the fuel electrode of the fuel cell stack 21 through the fuel gas supply pipe 21a, and air supplied as sweep gas by the air supply system 50 is introduced into the air electrode of the fuel cell stack 21 through the oxidant gas supply pipe 21b. When power having a predetermined voltage is supplied between the terminals of the fuel cell stack 21 (reversibly operated solid oxide cell stack) by the power supply, water vapor introduced into the fuel electrode is decomposed into hydrogen and oxygen ions (O²⁻) by an electrolytic action in the fuel electrode, and the oxygen ions pass through the electrolyte to generate oxygen in the air electrode. Note that, in the present embodiment, since a small amount of hydrogen gas is also supplied to the fuel electrode together with water vapor, the fuel electrode is maintained in a reducing atmosphere, and oxidation degradation of the fuel electrode can be suppressed. The hydrogen gas generated at the fuel electrode is discharged as a fuel electrode off-gas together with water vapor not subjected to electrolytic reaction, exchanges heat with water vapor or the like supplied from the water supply system 80 to the fuel electrode in the heat exchanger 23, and then is discharged to the outside of the module case 29. The fuel electrode off-gas containing hydrogen gas and water vapor is supplied to the circulation system 60 through the fuel electrode off-gas pipe 62, cooled by the condenser 61 provided in the circulation system 60 to remove the water vapor, and then stored in the hydrogen tank 2 via a collecting pipe 3 and an on-off valve 4. Note that the on-off valve 4 is closed in the FC mode and opened in the EC mode. Furthermore, part of the fuel electrode off-gas (hydrogen gas) that has passed through the condenser 61 is supplied to the combustor 22 through the fuel electrode off-gas pipe 63. On the other hand, the oxygen gas generated at the air electrode is directly supplied to the combustor 22 as an air electrode off-gas together with the air passing through the air electrode.

Combustion heat generated by the combustion of the mixed gas of the fuel electrode off-gas and the air electrode off-gas in the combustor 22 is transmitted to the evaporator 25. The evaporator 25 evaporates water (raw water) supplied from the water supply system 80 to generate water vapor, and increases the temperature of the generated water vapor. Furthermore, in the combustor 22, combustion exhaust gas is generated, and the generated combustion exhaust gas exchanges heat with air supplied from the air supply system 50 to the air electrode in the heat exchanger 24, then passes through the combustion exhaust gas pipe 72, passes through the exhaust heat recovery system 70, and is discharged to the outside air.

In the fuel cell system 10B according to another embodiment configured as described above, the FC mode and the EC mode can be switched and performed depending on the power demand. For example, the FC mode can be selected in a case where the load L requests power, and the EC mode can be selected in a case where the load L does not request power. Furthermore, in the fuel cell system 10B that has entered into the demand response contract, the FC mode can be selected in a case where a decrease DR for reducing the power demand is requested, and the EC mode can be selected in a case where an increase DR for increasing the power demand is requested.

In the embodiment described above, each of the plurality of power generation modules 20 included in the fuel cell system 10 includes one fuel cell stack 21. However, all or some of the plurality of power generation modules 20 may include a plurality of fuel cell stacks 21 connected in series.

In the embodiment described above, the module control device 90 and the integrated control device 100 are configured by separate control units, but may be configured by a single control unit.

### Summary Of Present Embodiment

As described above, the fuel cell system (10) of the present disclosure is a fuel cell system (10) including a plurality of power generation units (11) each of which includes one or more fuel cell stacks (21) that generate power by a reaction between fuel gas and oxidant gas, a combustion unit (22) that burns mixed gas of residual fuel gas and residual oxidant gas from the fuel cell stack (21), a heat insulating case (29) that houses the fuel cell stack (21) and the combustion unit (22), a fuel supply system (40) that supplies the fuel gas to the fuel cell stack (21), and an oxidant gas supply system (50) that supplies the oxidant gas to the fuel cell stack (21), in which fuel cell stacks (21) are connected in series between the plurality of power generation units (11), the fuel cell system includes a start-up control unit (90, 100) that, when start-up of the system (10) is requested, supplies the fuel gas and the oxidant gas to each of the plurality of fuel cell stacks (21) and burns the fuel gas and the oxidant gas in the combustion unit (22) to start a warm-up operation of the plurality of fuel cell stacks (21), and when all of the plurality of fuel cell stacks (21) are in a power generatable state, that starts current sweep to start power generation of the plurality of fuel cell stacks (21).

In the fuel cell system of the present disclosure, when all of the plurality of fuel cell stacks connected in series reach the power generatable state, the current sweep is started to cause the plurality of fuel cell stacks to simultaneously generate power. As a result, it is possible to prevent the current from being swept from some low-temperature fuel cell stacks and to suppress the degradation of the fuel cell stacks.

The fuel cell system (10) of the present disclosure may include a warm-up start timing adjustment unit (100) that adjusts a timing of start of a warm-up operation of the plurality of fuel cell stacks (21) in a manner that the plurality of fuel cell stacks (21) simultaneously reach a power generatable state.

If the timings at which the plurality of fuel cell stacks reach the power generatable state are shifted, wasteful fuel consumption for maintaining the power generatable state in the fuel cell stack that has reached the power generatable state early occurs. In the fuel cell system of the present disclosure, by adjusting the timing of start of the warm-up operation of the plurality of fuel cell stacks, the plurality of fuel cell stacks can simultaneously reach the power generatable state, and the occurrence of wasteful fuel consumption can be suppressed.

The fuel cell system (10) of the present disclosure including a warm-up start timing adjustment unit (100) may include a storage unit (104) that stores a required time required for each of the plurality of fuel cell stacks (21) to reach a power generatable state, and the warm-up start timing adjustment unit (100) may adjust a timing of start of a warm-up operation in the plurality of fuel cell stacks (21) based on a past required time stored in the storage unit (104) in a manner that the plurality of fuel cell stacks (21) simultaneously reach the power generatable state when the system (10) starts up next or later.

As a result, the plurality of fuel cell stacks can simultaneously reach the power generatable state more reliably.

The fuel cell system (10) of the present disclosure including a warm-up start timing adjustment unit (100) may include a storage unit (104) that stores in advance a timing of start of a warm-up operation for each of the fuel cell stacks (21), and the warm-up start timing adjustment unit (100) may adjust the timing of start of the warm-up operation in the plurality of fuel cell stacks (21) based on the timing of start stored in the storage unit (104).

For example, by storing in advance the timing of start experimentally obtained in the storage unit, the plurality of fuel cell stacks can simultaneously reach the power generatable state.

The fuel cell system (10) of the present disclosure may include a fuel supply amount regulating unit (90) that monitors a progress status of a warm-up operation in the plurality of fuel cell stacks (21) and regulates a supply amount of the fuel gas to each of the plurality of fuel cell stacks (21) based on the progress status of the warm-up operation.

As a result, wasteful fuel consumption can be suppressed more reliably.

In the fuel cell system (10) of the present disclosure including a fuel supply amount regulating unit (90), the fuel supply amount regulating unit (90) may reduce a supply amount of the fuel gas to a fuel cell stack (21) that has completed a warm-up operation earlier among the plurality of fuel cell stacks (21) as compared with the supply amount of the fuel gas to the fuel cell stack (21) during the warm-up operation, the fuel supply amount regulating unit (90) may reduce a supply amount of the fuel gas to a fuel cell stack (21) in which a warm-up operation progresses among the plurality of fuel cell stacks (21) as compared with the supply amount of the fuel gas to a fuel cell stack (21) in which the warm-up operation delays, and the fuel supply amount regulating unit (90) may regulate a supply amount of the fuel gas to each of the plurality of fuel cell stacks (21) in a manner that a temperature of each of the plurality of fuel cell stacks (21) rises based on a target gradient.

The fuel cell system (10) of the present disclosure may include a plurality of individual control units (90) each of which controls a corresponding power generation unit (11) among the plurality of power generation units (11) and an integrated control unit (100) that integrally controls the plurality of individual control units, the plurality of individual control units (90) may execute control in a manner that a corresponding fuel cell stack (21) warms up when instructed to start a warm-up operation in a start-up process, and transmit information that power generation is enabled to the integrated control unit (100) when the warm-up of the corresponding fuel cell stack (21) is completed, and the integrated control unit (100) may start current sweep from the plurality of fuel cell stacks (21) based on reception of information that power generation of the corresponding fuel cell stack (21) is enabled from all of the plurality of individual control units (90).

In the fuel cell system in which the fuel cell stacks are connected in series between the plurality of power generation units, when instructed to start the warm-up operation in the start-up process, the plurality of individual control units execute control in a manner that the corresponding fuel cell stack is warmed up, and when the warm-up of the corresponding fuel cell stack is completed, the individual control units transmit information that power generation is enabled to the integrated control unit. The integrated control unit starts the current sweep from the plurality of fuel cell stacks on the basis of the reception of the information that the warm-up of the corresponding fuel cell stack is completed from all of the plurality of individual control units. As a result, when the current sweep starts, it is possible to prevent an excessive current from flowing through a low-temperature fuel cell stack, and it is possible to more reliably suppress the degradation of the fuel cell stack.

In the fuel cell system (10) of the present disclosure including a plurality of individual control units (90) and an integrated control unit (100), the plurality of individual control units (90) may check that a corresponding power generation unit (11) is operable prior to a warm-up operation of a corresponding fuel cell stack (21) in a start-up process, and transmit a result of the check to the integrated control unit (100), and the integrated control unit (100) may instruct the plurality of individual control units (90) to start the warm-up operation of the corresponding fuel cell stack (21) based on reception of information that the corresponding power generation unit (11) is operable from all of the plurality of individual control units (90).

As a result, it is possible to avoid the start of the warm-up operation of a fuel cell stack not in the operable state among the plurality of fuel cell stack connected in series.

In the fuel cell system (10) of the present disclosure including a plurality of individual control units (90) and an integrated control unit (100), the plurality of individual control units (90) may transmit, to the integrated control unit (100), information that a corresponding fuel cell stack (21) can generate power based on a fact that a temperature of the corresponding fuel cell stack is equal to or higher than a predetermined temperature in a warm-up operation of the corresponding fuel cell stack (21), and the integrated control unit (100) may instruct the plurality of individual control units (90) to start a stop operation of the corresponding fuel cell stack (21) in a case where the integrated control unit does not receive information that power generation is enabled before an elapsed time from start of the warm-up operation reaches a predetermined time from any of the plurality of individual control units (90).

As a result, it is possible to prevent a current from being swept from a low-temperature fuel cell stack in which the warm-up operation is not completed among the plurality of fuel cell stacks connected in series, and to suppress the failure of the fuel cell stack. Here, “case where the integrated control unit does not receive information that power generation is enabled” includes a case where the elapsed time reaches a predetermined time while the integrated control unit does not receive the information that power generation is enabled from any of the individual control units, and a case where the elapsed time reaches the predetermined time and the integrated control unit receives the information that power generation is not enabled from any of the individual control units.

In the fuel cell system (10) of the present disclosure including a plurality of individual control units (90) and an integrated control unit (100), the plurality of individual control units (90) may transmit, to the integrated control unit (100), information that a corresponding fuel cell stack (21) can generate power based on a fact that a temperature of the corresponding fuel cell stack (21) is equal to or higher than a predetermined temperature and an open circuit voltage of the corresponding fuel cell stack (21) is equal to or higher than a predetermined voltage in a warm-up operation of the corresponding fuel cell stack (21), and transmit, to the integrated control unit (100), information that the corresponding fuel cell stack (21) is determined to be degraded and cannot generate power in a case where an elapsed time from start of the warm-up operation reaches a predetermined time before the temperature of the corresponding fuel cell stack (21) becomes equal to or higher than the predetermined temperature, and transmit, to the integrated control unit (100), information that it is determined to be a system failure and power cannot be generated in a case where the elapsed time from the start of the warm-up operation reaches the predetermined time before the open circuit voltage becomes equal to or higher than the predetermined voltage, and the integrated control unit (100) may instruct the plurality of individual control units (90) to start the stop operation based on reception of information that power cannot be generated from any of the plurality of individual control units (90).

As a result, it possible to identify the cause of the abnormality in a case where the fuel cell stack does not reach the power generatable state even by the warm-up operation, and to improve maintainability.

In the fuel cell system (10) of the present disclosure including a plurality of individual control units (90) and an integrated control unit (100), the plurality of individual control units (90) may perform a stop operation of supplying the fuel gas and the oxidant gas to a corresponding fuel cell stack (21) within a range equal to or lower than a lower combustion limit in a stop process, and stop supply of the fuel gas and the oxidant gas based on a fact that a temperature of the corresponding fuel cell stack (21) is lower than a predetermined temperature and transmit a notification that the stop operation is completed to the integrated control unit (100), and the integrated control unit (100) may instruct a corresponding individual control unit (90) to perform an immediate stop operation of immediately stopping the supply of the fuel gas and the oxidant gas in a case where information that the stop operation is completed is not received from any of the plurality of individual control units (90) before an elapsed time from start of the stop operation reaches a predetermined time.

As a result, even in a case where any of the plurality of fuel cell stacks cannot complete the stop operation, it is possible to appropriately handle such a case. Here, “case where the information that the stop operation is completed is not received” includes a case where the elapsed time reaches a predetermined time while the integrated control unit does not receive the information that the stop operation is completed from any of the individual control units, and a case where the elapsed time reaches the predetermined time and the integrated control unit receives the information that the stop operation is not completed from any of the individual control units.

Although the mode for carrying out the present disclosure has been described above with reference to the embodiment, the present disclosure is not limited to such embodiment at all, and can be carried out in various forms without departing from the gist of the present disclosure.

Note that, the present specification also discloses a technical idea in which “the fuel cell system according to claim 1” is changed to “the fuel cell system according to any one of claims 1 to 4” in claim 5 as originally filed. In addition, the present specification also discloses a technical idea in which “the fuel cell system according to claim 9” is changed to “the fuel cell system according to any one of claims 9 to 12” in claim 13 as originally filed.

### INDUSTRIAL APPLICABILITY

The present disclosure is applicable to a fuel cell system manufacturing industry.

### REFERENCE SIGNS LIST

10, 10B: Fuel cell system, 21: Fuel cell stack, 11: Power generation unit, 22: Combustor (combustion unit), 29: Module case (case), 40: Fuel supply system, 50: Air supply system (oxidant gas supply system), 90: Module control device (individual control unit, start-up control unit, fuel supply amount regulating unit), 100: Integrated control device (integrated control unit, start-up control unit, warm-up start timing adjustment unit), and 104: EEPROM (storage unit)

1. A fuel cell system comprising a plurality of power generation units each of which includes one or more fuel cell stacks that generate power by a reaction between fuel gas and oxidant gas, a combustion unit that burns mixed gas of residual fuel gas and residual oxidant gas from the fuel cell stack, a heat insulating case that houses the fuel cell stack and the combustion unit, a fuel supply system that supplies the fuel gas to the fuel cell stack, and an oxidant gas supply system that supplies the oxidant gas to the fuel cell stack, in which fuel cell stacks are connected in series between the plurality of power generation units, the fuel cell system comprising:
a start-up control unit that, when start-up of the system is requested, supplies the fuel gas and the oxidant gas to each of the plurality of fuel cell stacks and burns the fuel gas and the oxidant gas in the combustion unit to start a warm-up operation of the plurality of fuel cell stacks, and when all of the plurality of fuel cell stacks are in a power generatable state, that starts current sweep to start power generation of the plurality of fuel cell stacks.

2. The fuel cell system according to claim 1, further comprising a warm-up start timing adjustment unit that adjusts a timing of start of a warm-up operation of the plurality of fuel cell stacks in a manner that the plurality of fuel cell stacks simultaneously reach a power generatable state.

3. The fuel cell system according to claim 2 further comprising
a storage unit that stores a required time required for each of the plurality of fuel cell stacks to reach a power generatable state, wherein
the warm-up start timing adjustment unit adjusts a timing of start of a warm-up operation in the plurality of fuel cell stacks based on a past required time stored in the storage unit in a manner that the plurality of fuel cell stacks simultaneously reach the power generatable state when the system starts up next or later.

4. The fuel cell system according to claim 2, further comprising
a storage unit that stores in advance a timing of start of a warm-up operation for each of the fuel cell stacks, wherein
the warm-up start timing adjustment unit adjusts the timing of start of the warm-up operation in the plurality of fuel cell stacks based on the timing of start stored in the storage unit.

5. The fuel cell system according to claim 1, further comprising
a fuel supply amount regulating unit that monitors a progress status of a warm-up operation in the plurality of fuel cell stacks and regulates a supply amount of the fuel gas to each of the plurality of fuel cell stacks based on the progress status of the warm-up operation.

6. The fuel cell system according to claim 5, wherein
the fuel supply amount regulating unit reduces a supply amount of the fuel gas to a fuel cell stack that has completed a warm-up operation earlier among the plurality of fuel cell stacks as compared with the supply amount of the fuel gas to the fuel cell stack during the warm-up operation.

7. The fuel cell system according to claim 5, wherein
the fuel supply amount regulating unit reduces a supply amount of the fuel gas to a fuel cell stack in which a warm-up operation progresses among the plurality of fuel cell stacks as compared with the supply amount of the fuel gas to a fuel cell stack in which the warm-up operation delays.

8. The fuel cell system according to claim 5, wherein
the fuel supply amount regulating unit regulates a supply amount of the fuel gas to each of the plurality of fuel cell stacks in a manner that a temperature of each of the plurality of fuel cell stacks rises based on a target gradient.

9. The fuel cell system according to claim 1, further comprising:
a plurality of individual control units each of which controls a corresponding power generation unit among the plurality of power generation units; and
an integrated control unit that integrally controls the plurality of individual control units, wherein
the plurality of individual control units execute control in a manner that a corresponding fuel cell stack warms up when instructed to start a warm-up operation in a start-up process, and transmit information that power generation is enabled to the integrated control unit when the warm-up of the corresponding fuel cell stack is completed, and
the integrated control unit starts current sweep from the plurality of fuel cell stacks based on reception of information that power generation of the corresponding fuel cell stack is enabled from all of the plurality of individual control units.

10. The fuel cell system according to claim 9, wherein
the plurality of individual control units check that a corresponding power generation unit is operable prior to a warm-up operation of a corresponding fuel cell stack in a start-up process, and transmits a result of the check to the integrated control unit, and
the integrated control unit instructs the plurality of individual control units to start the warm-up operation of the corresponding fuel cell stack based on reception of information that the corresponding power generation unit is operable from all of the plurality of individual control units.

11. The fuel cell system according to claim 9, wherein
the plurality of individual control units transmit, to the integrated control unit, information that a corresponding fuel cell stack can generate power based on a fact that a temperature of the corresponding fuel cell stack is equal to or higher than a predetermined temperature in a warm-up operation of the corresponding fuel cell stack, and
the integrated control unit instructs the plurality of individual control units to start a stop operation of the corresponding fuel cell stack in a case where the integrated control unit does not receive information that power generation is enabled before an elapsed time from start of the warm-up operation reaches a predetermined time from any of the plurality of individual control units.

12. The fuel cell system according to claim 11, wherein the plurality of individual control units transmit, to the integrated control unit, information that a corresponding fuel cell stack can generate power based on a fact that a temperature of the corresponding fuel cell stack is equal to or higher than a predetermined temperature and an open circuit voltage of the corresponding fuel cell stack is equal to or higher than a predetermined voltage in a warm-up operation of the corresponding fuel cell stack, and transmits, to the integrated control unit, information that the corresponding fuel cell stack is determined to be degraded and cannot generate power in a case where an elapsed time from start of the warm-up operation reaches a predetermined time before the temperature of the corresponding fuel cell stack becomes equal to or higher than the predetermined temperature, and transmits, to the integrated control unit, information that it is determined to be a system failure and power cannot be generated in a case where the elapsed time from the start of the warm-up operation reaches the predetermined time before the open circuit voltage becomes equal to or higher than the predetermined voltage, and
the integrated control unit instructs the plurality of individual control units to start the stop operation based on reception of information that power cannot be generated from any of the plurality of individual control units.

13. The fuel cell system according to claim 9, wherein
the plurality of individual control units perform a stop operation of supplying the fuel gas and the oxidant gas to a corresponding fuel cell stack within a range equal to or lower than a lower combustion limit in a stop process, and stops supply of the fuel gas and the oxidant gas based on a fact that a temperature of the corresponding fuel cell stack is lower than a predetermined temperature and transmits a notification that the stop operation is completed to the integrated control unit, and
the integrated control unit instructs a corresponding individual control unit to perform an immediate stop operation of immediately stopping the supply of the fuel gas and the oxidant gas in a case where information that the stop operation is completed is not received from any of the plurality of individual control units before an elapsed time from start of the stop operation reaches a predetermined time.
